(19) United States
(12) Patent Application Publication
(10) Pub. No.: US 2026/0024277 A1
(43) Pub. Date: Jan. 22, 2026

(54) VIRTUAL PICTURE GENERATION METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: He WANG, Shenzhen (CN)

(73) Assignee: Tencent Technology (Shenzhen) Company Limited, Shenzhen (CN)

(21) Appl. No.: 19/339,754

(22) Filed: Sep. 25, 2025

Related U.S. Application Data
(63) Continuation of application No. PCT/CN2024/104664, filed on Jul. 10, 2024.

(30) Foreign Application Priority Data
Sep. 11, 2023 (CN) 202311164963.0

(51) Int. Cl. G06T 15/80; G06T 15/08

(52) U.S. Cl. CPC G06T 15/80; G06T 15/08

(57) ABSTRACT

This disclosure provides a virtual picture generation method and apparatus, a device, a storage medium, and a program product. The method includes: obtaining a preset virtual scene, the preset virtual scene including a plurality of voxels, and the voxel including a plurality of voxel faces having different normal directions; performing, for each voxel, rasterization on the voxel in each normal direction of the voxel to obtain a voxel face element corresponding to each voxel face of the voxel, the voxel face element being configured for describing virtual scene information of the voxel in the corresponding normal direction; selecting a target voxel face element associated with a target virtual camera in the preset virtual scene from the plurality of voxel face elements; and performing picture shading on the preset virtual scene based on the target voxel face element, to obtain a target virtual picture.

### RELATED APPLICATION

This application is a continuation of PCT/CN2024/104664, filed on Jul. 10, 2024, which claims priority to Chinese Patent Application No. 202311164963.0, filed on Sep. 11, 2023, which are both hereby incorporated by reference in their entireties.

### FIELD OF THE TECHNOLOGY

This application relates to the field of computer technologies, and in particular, to a virtual picture generation method and apparatus, an electronic device, a computer-readable storage medium, and a computer program product.

### BACKGROUND OF THE DISCLOSURE

In recent years, with the development of computer technologies, industries such as gaming, film and television, and virtual reality have thrived. A virtual object, a virtual light source, and a virtual camera are disposed in a virtual scene. The virtual light source is configured to provide illumination light to the virtual object located in the virtual scene. The virtual camera is configured to capture a scene picture based on an angle of the virtual camera in the virtual scene. An application computes surface reflected light from the virtual object based on the illumination light provided by the virtual light source and the angle of the virtual camera, to obtain the scene picture through rendering.

In the related art, for virtual picture generation, generally, a voxel corresponding to each frame of virtual picture is separately rasterized to obtain the corresponding virtual picture. In this way, because there may be a voxel overlap between different virtual pictures, separately performing voxel rasterization for each frame of virtual picture causes repeated execution of same processing on a duplicate voxel between different frames, wasting processing resources and resulting in low virtual picture generation efficiency.

### SUMMARY

Embodiments of this disclosure provide a virtual picture generation method and apparatus, an electronic device, a computer-readable storage medium, and a computer program product, to effectively improve virtual picture generation efficiency.

Technical solutions of the embodiments of this disclosure are implemented as follows.

An embodiment of this disclosure provides a virtual picture generation method, including:
obtaining a preset virtual scene, the preset virtual scene including a plurality of voxels, and the voxel including a plurality of voxel faces having different normal directions;
performing, for each voxel, rasterization on the voxel in each normal direction of the voxel to obtain a voxel face element corresponding to each voxel face of the voxel, the voxel face element being configured for describing virtual scene information of the voxel in the corresponding normal direction;
selecting a target voxel face element associated with a target virtual camera in the preset virtual scene from the plurality of voxel face elements; and
performing picture shading on the preset virtual scene based on the target voxel face element, to obtain a target virtual picture.

An embodiment of this disclosure provides a virtual picture generation apparatus, including:
an obtaining module, configured to obtain a preset virtual scene, the preset virtual scene including a plurality of voxels, and the voxel including a plurality of voxel faces having different normal directions;
a rasterization module, configured to perform, for each voxel, rasterization on the voxel in each normal direction of the voxel to obtain a voxel face element corresponding to each voxel face of the voxel, the voxel face element being configured for describing virtual scene information of the voxel in the corresponding normal direction;
a selection module, configured to select a target voxel face element associated with a target virtual camera in the preset virtual scene from the plurality of voxel face elements; and
a picture shading module, configured to perform picture shading on the preset virtual scene based on the target voxel face element, to obtain a target virtual picture.

An embodiment of this disclosure provides an electronic device, including:
a memory, configured to store computer-executable instructions or a computer program; and
a processor, configured to implement, when executing the computer-executable instructions or the computer program stored in the memory, the virtual picture generation method provided in the embodiments of this disclosure.

An embodiment of this disclosure provides a computer-readable storage medium, having computer-executable instructions stored therein. The computer-readable instructions are configured for, when executed by a processor, causing the virtual picture generation method provided in the embodiments of this disclosure to be implemented.

An embodiment of this disclosure provides a computer program product. The computer program product includes a computer program or computer-executable instructions. The computer program or the computer-executable instructions are stored in a computer-readable storage medium. A processor of an electronic device reads the computer-executable instructions from the computer-readable storage medium. The processor executes the computer-executable instructions, so that the electronic device performs the virtual picture generation method provided in the embodiments of this disclosure.

The embodiments of this disclosure have the following beneficial effects.

The preset virtual scene is obtained, and rasterization is performed for each voxel in the preset virtual scene to obtain the voxel face elements corresponding to the voxel. In this way, all voxel face elements in the preset virtual scene are obtained. For any frame of target virtual picture of the preset virtual scene, a target voxel face element associated with a target virtual camera is directly selected from the plurality of voxel face elements, to obtain the target virtual picture. In this way, even if there may be a voxel overlap between different virtual pictures, because all the voxel face elements in the preset virtual scene have been determined, the target virtual picture can be generated by directly selecting the target voxel face element associated with the target virtual camera from the plurality of voxel face elements, without performing a same processing process on a duplicate voxel between different picture frames. Therefore, virtual picture generation efficiency is effectively improved.

### BRIEF DESCRIPTION OF THE DRAWINGS

FIG. 1 is a schematic diagram of an architecture of a virtual picture generation system according to an embodiment of this disclosure.

FIG. 2 is a schematic diagram of a structure of an electronic device for generating a virtual picture according to an embodiment of this disclosure.

FIG. 3 is a schematic flowchart of operation 101 to operation 104 in a virtual picture generation method according to an embodiment of this disclosure.

FIG. 4 is a schematic flowchart of operation 1011 to operation 1013 in a virtual picture generation method according to an embodiment of this disclosure.

FIG. 5 is a schematic principle diagram of an initial voxel in a virtual picture generation method according to an embodiment of this disclosure.

FIG. 6 is a schematic flowchart of operation 1021 to operation 1024 in a virtual picture generation method according to an embodiment of this disclosure.

FIG. 7 is a schematic principle diagram of a candidate object point in a virtual picture generation method according to an embodiment of this disclosure.

FIG. 8 is a schematic flowchart of operation 1031A to operation 1033A in a virtual picture generation method according to an embodiment of this disclosure.

FIG. 9 is a schematic flowchart of operation 1031B in a virtual picture generation method according to an embodiment of this disclosure.

FIG. 10 is a schematic flowchart of operation 1031C in a virtual picture generation method according to an embodiment of this disclosure.

FIG. 11 is a schematic flowchart of operation 1041 to operation 1045 in a virtual picture generation method according to an embodiment of this disclosure.

FIG. 12 is a schematic principle diagram of a voxel in a virtual picture generation method according to an embodiment of this disclosure.

FIG. 13 is a schematic principle diagram of voxelization in a virtual picture generation method according to an embodiment of this disclosure.

FIG. 14 is a schematic principle diagram of a face element in a virtual picture generation method according to an embodiment of this disclosure.

FIG. 15 is a schematic diagram of effects of a virtual picture according to the related art.

FIG. 16 is a schematic diagram of effects of a first virtual picture according to an embodiment of this disclosure.

FIG. 17 is a schematic diagram of effects of a second virtual picture according to an embodiment of this disclosure.

FIG. 18 is a schematic diagram of effects of a face element illumination cache according to the related art.

FIG. 19 is a schematic diagram of effects of a face element illumination cache according to an embodiment of this disclosure.

### DESCRIPTION OF EMBODIMENTS

To make the objectives, technical solutions, and advantages of this disclosure clearer, the following describes this disclosure in further detail with reference to the accompanying drawings. The described embodiments are not to be considered as a limitation on this disclosure. All other embodiments obtained by a person of ordinary skill in the art without creative efforts shall fall within the protection scope of this disclosure.

In the following descriptions, related “some embodiments” describe a subset of all possible embodiments. However, the “some embodiments” may be the same subset or different subsets of all the possible embodiments, and may be combined with each other without conflict.

The term “first/second/third” involved in the following descriptions is merely used to distinguish between similar objects and does not indicate a specific order of the objects. A specific order or sequence indicated by the term “first/second/third” can be changed where permitted, so that the embodiments of this disclosure described herein can be implemented in an order other than that illustrated or described herein.

Unless otherwise defined, all technical and scientific terms used in this specification have same meanings as those usually understood by a person skilled in the art of this disclosure. The terms used in this specification are merely intended to describe the objectives of the embodiments of this disclosure, but are not intended to limit this disclosure.

Before the embodiments of this disclosure are further described in detail, descriptions are made on nouns and terms in the embodiments of this disclosure, and the nouns and terms in the embodiments of this disclosure are applicable to the following explanations.

(1) Vertex shader: is a program in computer graphics, and is configured to process and transform inputted vertex data. The vertex shader is usually executed on a graphics processing unit (GPU), and may perform computation on each inputted vertex and output transformed vertex data. During three-dimensional graphic rendering, the vertex shader is usually a first stage of a rendering pipeline. A main function of the vertex shader is to transform the inputted vertex data to project the vertex data to a screen. The vertex shader may perform various transformation operations, such as translation, rotation, scaling, and projection, to convert the vertex from a model space to a world space, a camera space, and a screen space. In addition to the transformation operation, the vertex shader may further perform another computing operation, for example, normal computation, texture coordinate computation, and illumination computation. These computations may be performed in the vertex shader for use in a subsequent rendering stage.

(2) Rendering: is a stage in which an image is finally made to conform to a three-dimensional (3D) scene. Rendering is also referred to by some as shading. However, once shading is referred to as shading, rendering is referred to as rendering. This is because rendering and shading are two distinct concepts in three-dimensional software, and the two words have similar but different functions. Shading is a display solution, usually appears in a main window of the three-dimensional software, and serves to assist in model observation like a wireframe of the three-dimensional model. Apparently, a shading mode makes it easier than a wireframe mode to understand a model structure, but it implements only simple display. For a digital image, it is referred to as a light-and-shade method. In advanced three-dimensional software like Maya, simple ray effects, shadow effects, and surface texture effects may be further displayed through shading. Certainly, high-quality shading effects need support from a professional three-dimensional graphics card that can accelerate and optimize display of a three-dimensional graphic. However, no matter how to perform optimization, the displayed three-dimensional graphic cannot be changed into a high-quality image. This is because shading uses a real-time display technology, and under a limit of a speed of hardware, ray effects such as reflection and refraction in the scene cannot be fed back in real time. However, in practical work, the model or the scene usually needs to be outputted as an image file, a video signal, or a film stock, and this needs a rendering program. A rendering process in graphics may be basically decomposed into two main tasks: visibility and shading. Rasterization may be a method for resolving a visibility problem. Visibility includes distinguishing which parts of a three-dimensional object are visible to a camera. Some parts of the object may be forbidden because they are either beyond a visible region of the camera or hidden by other objects.

(3) Pixel: Pixels are small squares constituting an image. These small squares each have a clear location and an allocated color value. Colors and locations of the small squares determine what the image presents. The pixel may be considered as an indivisible unit or element in the entire image. “Indivisible” means that the unit or element cannot be further divided into smaller units or elements and exists as a grid of a single color. Each lattice image includes a specific quantity of pixels, and these pixels determine a size of the image presented on a screen.

(4) In response to: This expression is configured for representing a condition or status on which one or more to-be-performed operations depend. When the condition or status is satisfied, the one or more operations may be performed immediately or have a set delay. Unless otherwise specified, there is no chronological order between the plurality of to-be-performed operations.

(5) Virtual scene: is a virtual scene displayed (or provided) when an application runs on a terminal. The virtual scene may be a simulated environment of a real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene. A dimension of the virtual scene is not limited in the embodiments of this disclosure. For example, the virtual scene may include the sky, the land, the ocean, and the like. The land may include an environment element like a desert or a city. A user may control a virtual object to move in the virtual scene.

(6) Voxel: The voxel is an abbreviation of a volume pixel. A volume including a voxel may be represented through volume rendering or by extracting a polygonal isosurface from a contour with a given threshold. As the name implies, the voxel is a smallest unit of digital data in segmentation of a three-dimensional space. The voxel is used in the fields of three-dimensional imaging, scientific data, medical images, and the like. Conceptually, the voxel is similar to a pixel, which is a smallest unit in a two-dimensional space. The pixel is used for image data of a two-dimensional computer image.

(7) Camera model: is configured for describing a process of mapping a coordinate point in a three-dimensional world coordinate system to a two-dimensional image plane, and is a bond for implementing a connection between a point in a three-dimensional space and a point on a two-dimensional plane. The camera model includes at least a pinhole camera model and a fisheye camera model. The pinhole camera model is used as an example for description. There are four coordinate systems in the pinhole camera model: the three-dimensional world coordinate system, a three-dimensional camera coordinate system, a two-dimensional image physical coordinate system, and a two-dimensional image pixel coordinate system.

(8) Virtual object: is a moving or static object in a virtual scene. A moving virtual object includes an animal, a vehicle, a person, and the like in the virtual scene. A static virtual object includes a wall, a stone, a ground, and the like in the virtual scene.

(9) Virtual ray: is a ray in a virtual scene that is emitted by a virtual light source configured to illuminate the virtual scene. The virtual ray includes a direct ray and an indirect ray. The direct ray is a virtual ray that is emitted by the virtual light source and that is reflected by a virtual light point to a virtual camera. The indirect ray is a virtual ray that is emitted by the virtual light source and that reaches the virtual light point through at least one instance of reflection and is finally reflected by the virtual light point to the virtual camera.

(10) Virtual camera: is a “camera” built in computer animation software or a virtual engine. A function of the virtual camera for representing a viewpoint during animation production is equivalent to a camera in a conventional sense. An object shot by the virtual camera is completely different from an object shot by a physical camera, but functions of the cameras are quite similar. The physical camera shoots a real person or an actually established scene. The virtual camera shoots a model established in three-dimensional software, and can implement infinite possibilities. The virtual camera is presented in the virtual engine in a form of an icon, and also has parameters such as a lens, a focal length, a focus, an aperture, and a depth of field. The virtual camera can implement camera actions such as “pushing, pulling, shaking, moving, following, throwing, rising, lowering, and comprehensive movement”, and can implement shooting effects that are difficult or even impossible for the physical camera to implement, for example, passing through a wall, through a keyhole, or through an object. Parameters of the physical camera that need to be adjusted are distributed on a body of the physical camera, and need manual operations. A camera parameter of the virtual camera is a button or a value input bar integrated in a panel. An operator only needs to enter a parameter or drag a mouse. Sometimes, a motion path of the virtual camera may be determined by using only several key frames. During actual shooting, the physical camera usually needs to have a stabilizer or a motion control system. However, even in this case, a picture still shakes.

(11) Virtual engine: is a core component of an editable computer virtual system or an interactive real-time image application that has been written. The system provides various tools required for writing a virtual scene for a designer of the virtual scene, and aims at enabling the designer to easily and quickly write a program. The virtual engine includes a rendering engine (the rendering engine includes a two-dimensional rendering engine and a three-dimensional rendering engine), a physical engine, a collision detection engine, a sound effect engine, a script engine, an animation engine, an artificial intelligence engine, a network engine, a scene management engine, and the like.

(12) Virtual light source: is a “light source” built in computer animation software or a virtual engine. A function of the virtual light source for representing a viewpoint during animation production is equivalent to a physical light source in a conventional sense. An object irradiated by the virtual light source is completely different from an object irradiated by the physical light source, but functions of the light sources are quite similar. The physical light source irradiates a real person or an actually established scene. The virtual light source irradiates a model established in three-dimensional software, and can implement infinite possibilities.

(13) Rasterization: is a process of converting vertex data into a fragment, functions to convert a graphic into an image including grids, and is characterized in that each element corresponds to one pixel in a frame buffer. Rasterization is the process of converting the vertex data into the fragment. Each element in the fragment corresponds to one pixel in the frame buffer. Rasterization is actually a process of converting a geometric primitive into a two-dimensional image. This process includes two parts of work: The first part of work is determining which integer grid regions in window coordinates are occupied by basic primitives. The second part of work is allocating one color value and one depth value to each region. The fragment is generated in the rasterization process. A process of converting a mathematical description of an object and color information related to the object into a pixel on a screen for a corresponding location and a color for filling the pixel is referred to as rasterization.

(14) Face element: is a facet for describing an object surface, that is, a smallest unit for describing the object surface. The face element has a specific area, and correspondingly stores information about the object surface. The stored surface information may also be referred to as a face element parameter. The face element parameter may specifically include a location, a radius, a normal, an albedo, and the like of the face element.

(15) Pixel shader: The pixel shader is a program in computer graphics, and is configured to process and shade each pixel in a rendering pipeline. The pixel shader is usually executed on a GPU, and may perform computation on each pixel and output a final color value. During three-dimensional graphic rendering, the pixel shader is usually a last stage of the rendering pipeline. A main function of the pixel shader is to compute the final color value of each pixel based on inputted information such as a texture, light, and a material. The pixel shader may perform various computing operations, such as texture sampling, illumination computation, shadow computation, and transparency computation, to generate a final image.

(16) Voxelization (Scene Voxelization): is a technology for implementing efficient scene rendering and illumination computation. Voxelization converts an object and a geometric shape in a scene into a voxel representation for rendering and computation in a voxel space. A basic idea of voxelization is to convert the object and the geometric shape in the scene into the voxel representation for rendering and computation in the voxel space. In the voxel space, a voxel grid may be used to represent the object and the geometric shape in the scene. The voxel grid is a three-dimensional grid. Each grid unit represents one voxel, and may store information such as a location, a color, and a normal of the object.

In an implementation process of the embodiments of this disclosure, the applicant finds that the related art has the following problems.

In the related art, for virtual picture generation, generally, a voxel corresponding to each frame of virtual picture is separately rasterized to obtain the corresponding virtual picture. In this way, because there may be a voxel overlap between different virtual pictures, separately performing voxel rasterization for each frame of virtual picture causes repeated execution of same processing on a duplicate voxel between different frames, resulting in waste of processing resources and low virtual picture generation efficiency.

The embodiments of this disclosure provide a virtual picture generation method and apparatus, an electronic device, a computer-readable storage medium, and a computer program product, to effectively improve virtual picture generation efficiency. The following describes an exemplary disclosure of a virtual picture generation system provided in the embodiments of this disclosure.

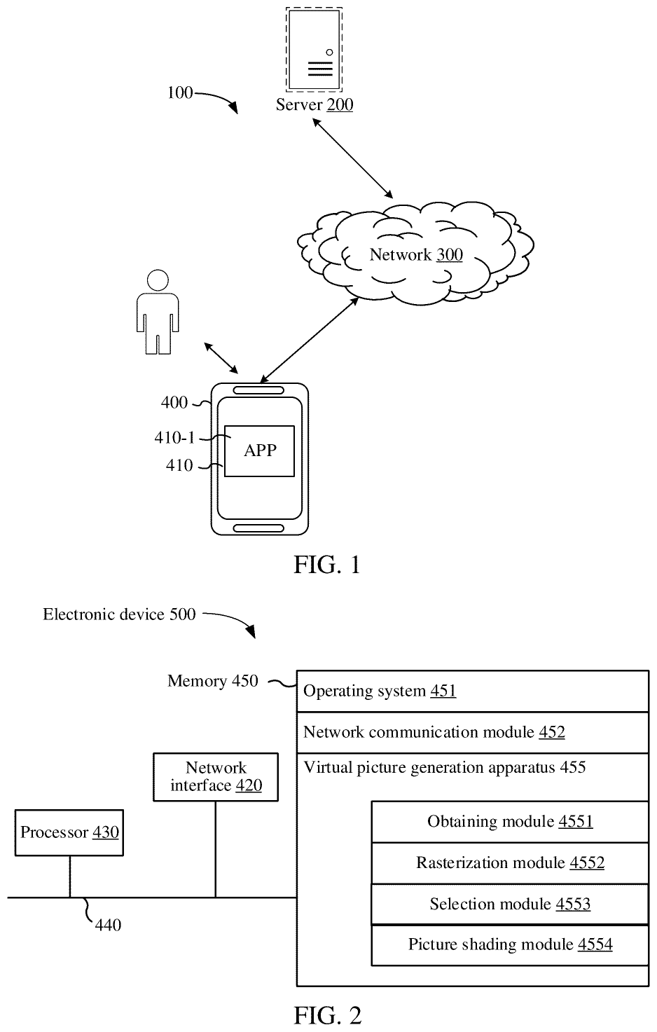

FIG. 1 is a schematic diagram of an architecture of a virtual picture generation system 100 according to an embodiment of this disclosure. A terminal (for example, a terminal 400 is shown) is connected to a server 200 through a network 300. The network 300 may be a wide area network, a local area network, or a combination thereof.

The terminal 400 is configured for a user to use a client 410, and displays a target virtual picture in a graphical interface 410-1 (for example, a graphical interface 410-1 is shown). The terminal 400 and the server 200 are connected to each other through a wired or wireless network.

In some embodiments, the server 200 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a smart speaker, a smart television, a smartwatch, an in-vehicle terminal, or the like, but is not limited thereto. The electronic device provided in the embodiments of this disclosure may be implemented as a terminal, or may be implemented as a server. The terminal and the server may be connected directly or indirectly in a wired or wireless communication mode. This is not limited in the embodiments of this disclosure.

In some embodiments, the server 200 obtains a preset virtual scene, performs, for each voxel, rasterization on the voxel in each normal direction of the voxel to obtain a voxel face element corresponding to each voxel face of the voxel, selects a target voxel face element associated with a target virtual camera from a plurality of voxel face elements, and transmits the target voxel face element to the terminal 400. The terminal 400 performs picture shading on the preset virtual scene based on the target voxel face element, to obtain a target virtual picture.

In some other embodiments, the server 200 obtains a preset virtual scene, performs, for each voxel, rasterization on the voxel in each normal direction of the voxel to obtain a voxel face element corresponding to each voxel face of the voxel, selects a target voxel face element associated with a target virtual camera from a plurality of voxel face elements, performs picture shading on the preset virtual scene based on the target voxel face element, to obtain a target virtual picture, and transmits the target virtual picture to the terminal 400.

In some other embodiments, the embodiments of this disclosure may be implemented by using a cloud technology. The cloud technology is a hosting technology that unifies a series of resources such as hardware, software, and networks within a wide area network or a local area network, to implement computation, storage, processing, and sharing of data.

The cloud technology is a generic term of a network technology, an information technology, an integration technology, a management platform technology, an application technology, and the like based on application of a cloud computing business model. The resources may form a resource pool and are used on demand, which is flexible and convenient. A cloud computing technology becomes important support. A backend service of a technology network system requires a lot of computing and storage resources.

FIG. 2 is a schematic diagram of a structure of an electronic device 500 for generating a virtual picture according to an embodiment of this disclosure. The electronic device 500 shown in FIG. 2 may be the server 200 or the terminal 400 in FIG. 1. The electronic device 500 shown in FIG. 2 includes at least one processor 430, a memory 450, and at least one network interface 420. The components in the electronic device 500 are coupled together through a bus system 440. The bus system 440 is further configured to implement connection and communication between the components. In addition to a data bus, the bus system 440 further includes a power bus, a control bus, and a state signal bus. However, for ease of clear description, all types of buses are marked as the bus system 440 in FIG. 2.

The processor 430 may be an integrated circuit chip having a signal processing capability, for example, a general-purpose processor, a digital signal processor (DSP) or another programmable logic device, a discrete gate or transistor logic device, or a discrete hardware component. The general-purpose processor may be a microprocessor, any conventional processor, or the like.

The memory 450 may be a removable memory, an irremovable memory, or a combination thereof. For example, a hardware device includes a solid-state memory, a hard disk drive, an optical disk drive, and the like. In an embodiment, the memory 450 includes one or more storage devices physically located away from the processor 430.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in this embodiment of this disclosure is intended to include any suitable type of memory.

In some embodiments, the memory 450 can store data to support various operations. Examples of the data include a program, a module, a data structure, or a subset or a superset thereof, which are described below by way of example.

An operating system 451 includes system programs configured for processing various basic system services and performing hardware-related tasks, for example, a framework layer, a core library layer, and a driver layer, and is configured to implement various basic services and process hardware-based tasks.

A network communication module 452 is configured to reach another electronic device through one or more (wired or wireless) network interfaces 420. An exemplary network interface 420 includes Bluetooth, wireless fidelity (Wi-Fi), a universal serial bus (USB), and the like.

In some embodiments, the virtual picture generation apparatus provided in the embodiments of this disclosure may be implemented in a software manner. FIG. 2 shows a virtual picture generation apparatus 455 stored in the memory 450. The apparatus may be software in a form of a program, a plug-in, or the like, and includes the following software modules: an obtaining module 4551, a rasterization module 4552, a selection module 4553, and a picture shading module 4554. These modules are logical modules, and therefore may be combined or further split in any manner based on implemented functions. Functions of the modules are described below.

In some other embodiments, the virtual picture generation apparatus provided in the embodiments of this disclosure may be implemented in a hardware manner. In an example, the virtual picture generation apparatus provided in the embodiments of the disclosure may be a processor in a form of a hardware decoding processor, programmed to perform the virtual picture generation method provided in the embodiments of the disclosure. For example, the processor in the form of the hardware decoding processor may use one or more application-specific integrated circuits (ASICs), a DSP, a programmable logic device (PLD), a complex programmable logic device (CPLD), a field-programmable gate array (FPGA), or another electronic component.

In some embodiments, the terminal or the server may implement the virtual picture generation provided in the embodiments of this disclosure by running a computer program or computer-executable instructions. For example, the computer program may be a native program (for example, a dedicated picture generation program) or a software module in the operating system, for example, a picture generation module that may be embedded in any program (for example, an instant messaging client, an album program, an electronic map client, or a navigation client), or may be a native application (APP), that is, a program that needs to be installed in the operating system for running. In summary, the computer program may be an application, a module, or a plug-in in any form.

The virtual picture generation method provided in the embodiments of this disclosure is described with reference to exemplary applications and implementations of the server or the terminal provided in the embodiments of this disclosure.

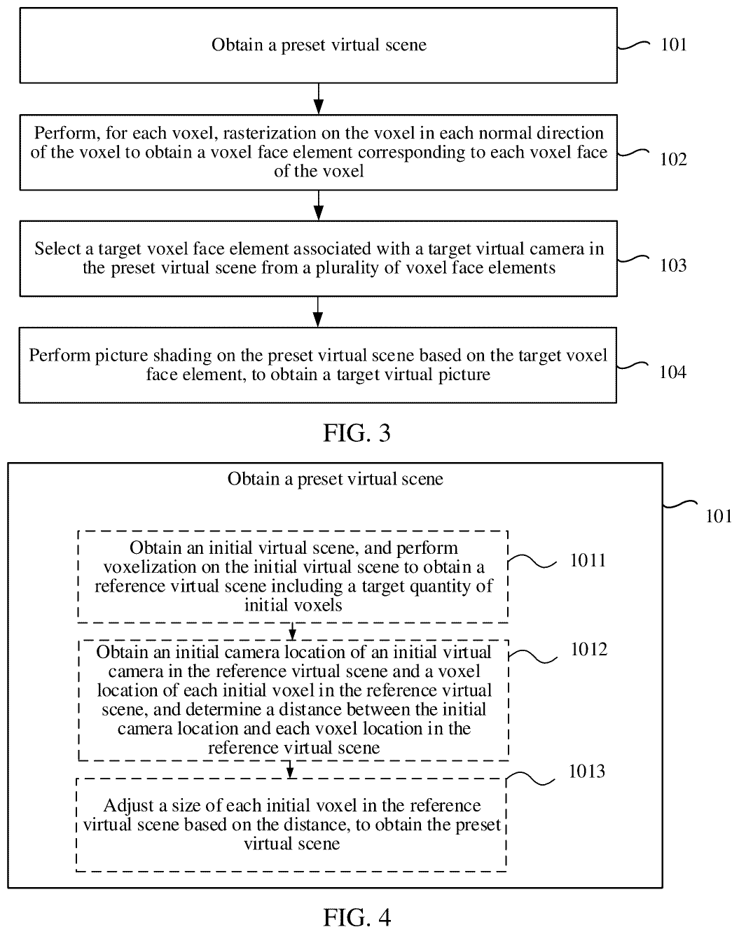

FIG. 3 is a schematic flowchart of operation 101 to operation 104 in a virtual picture generation method according to an embodiment of this disclosure. Descriptions are provided with reference to operation 101 to operation 104 shown in FIG. 3. The virtual picture generation method provided in this embodiment of this disclosure may be implemented by a server or a terminal alone, or may be cooperatively implemented by a server and a terminal. The following uses an example in which the method is implemented by the server alone for description.

In operation 101, a preset virtual scene is obtained.

In some embodiments, the preset virtual scene includes a plurality of voxels, and the voxel includes a plurality of voxel faces having different normal directions.

In some embodiments, the voxel is a smallest unit for segmentation of the preset virtual scene into a three-dimensional space. The voxel is a volume pixel of the preset virtual scene. The voxel is a volume pixel enclosed by a plurality of voxel faces. The voxel face is a region formed by voxel points having a same normal direction on a surface of the voxel. The voxel includes a plurality of voxel faces having different normal directions.

In some embodiments, a virtual scene is a virtual scene displayed (or provided) when an application runs on a terminal. The virtual scene may be a simulated environment of a real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene. A dimension of the virtual scene is not limited in the embodiments of this disclosure. For example, the virtual scene may include the sky, the land, the ocean, and the like. The land may include an environment element like a desert or a city. A user may control a virtual object to move in the virtual scene.

In an example, the preset virtual scene includes a plurality of cubic voxels, the cubic voxel includes six voxel faces having different normal directions, and normal directions corresponding to two neighboring voxel faces of the cubic voxel are perpendicular.

In some embodiments, FIG. 4 is a schematic flowchart of operation 1011 to operation 1013 in a virtual picture generation method according to an embodiment of this disclosure. Operation 101 shown in FIG. 3 may be implemented through operation 1011 to operation 1013 shown in FIG. 4.

In operation 1011, an initial virtual scene is obtained, and voxelization is performed on the initial virtual scene to obtain a reference virtual scene including a target quantity of initial voxels.

In some embodiments, voxelization is a technology for implementing efficient scene rendering and illumination computation. Voxelization converts an object and a geometric shape in a scene into a voxel representation for rendering and computation in a voxel space. A basic idea of voxelization is to convert the object and the geometric shape in the scene into the voxel representation for rendering and computation in the voxel space. In the voxel space, a voxel grid may be used to represent the object and the geometric shape in the scene. The voxel grid is a three-dimensional grid. Each grid unit represents one voxel, and may store information such as a location, a color, and a normal of the object.

In some embodiments, the initial voxel is a smallest unit for segmentation of the reference virtual scene into a scene space. The initial voxel is a volume pixel of the reference virtual scene. The initial voxel is a volume pixel enclosed by a plurality of voxel faces. The voxel face is a region formed by voxel points having a same normal direction on a surface of the initial voxel. The initial voxel includes a plurality of voxel faces having different normal directions.

In some embodiments, the reference virtual scene is an initial virtual scene including the target quantity of initial voxels, and the reference virtual scene is an initial virtual scene obtained through voxel division. Scene content in the initial virtual scene is completely the same as that in the reference virtual scene. The reference virtual scene includes the target quantity of initial voxels. A difference between the initial virtual scene and the reference virtual scene lies in that the target quantity of initial voxels exist in the reference virtual scene but not in the initial virtual scene. For example, when the initial virtual scene is a virtual scene R, the initial virtual scene is divided into an initial voxel R1 and an initial voxel R2, to obtain a reference virtual scene including the initial voxel R1 and the initial voxel R2.

In some embodiments, the performing voxelization on the initial virtual scene to obtain a reference virtual scene including a target quantity of initial voxels may be implemented in the following manner: obtaining the preset target quantity, and dividing the initial virtual scene into the target quantity of initial voxels, to obtain the reference virtual scene including the target quantity of initial voxels.

In some embodiments, the dividing the initial virtual scene into the target quantity of initial voxels, to obtain the reference virtual scene including the target quantity of initial voxels may be implemented in the following manner: obtaining a scene size of the initial virtual scene, dividing the scene size by the target quantity to obtain a size of the initial voxel, and dividing the initial virtual scene into the target quantity of initial voxels of the corresponding size, to obtain the reference virtual scene including the target quantity of initial voxels, each initial voxel in the reference virtual scene having the same size.

For example, the reference virtual scene includes a plurality of initial voxels, for example, an initial voxel A, an initial voxel B, and an initial voxel C. Therefore, the initial voxel A, the initial voxel B, and the initial voxel C form the entire reference virtual scene.

In some embodiments, initial sizes of the initial voxels in the reference virtual scene may be the same or different. The initial voxels correspond to different scene spaces in the reference virtual scene, and there is no overlap between the scene spaces in the reference virtual scene corresponding to the initial voxels. Therefore, repeated expression of same scene content in the reference virtual scene by different initial voxels is avoided, and after each initial voxel is subsequently processed, the entire reference virtual scene can be processed without repeatedly processing the same scene content, effectively performance of processing the reference virtual scene.

In this way, the initial virtual scene is divided into voxels having the same size, so that uniform allocation of computing resources to each target can be ensured, improving processing efficiency. The same voxel size can simplify a subsequent computing process because a same algorithm and computing method may be used during processing, reducing complexity. The voxels of the same size can use a storage space more efficiently because the voxels are arranged more regularly in a data structure. Uniform voxel division makes parallel processing easier because each voxel may be independently processed by a different processing unit. During three-dimensional graphic rendering, a voxelized scene can help perform light and shadow computation more quickly because a same rendering policy may be used for the voxels of the same size.

In some embodiments, the scene space is a three-dimensional space of a three-dimensional virtual scene in a world space of a virtual engine. The world space may accommodate a scene space of at least one virtual scene, that is, the world space includes at least one scene space. Because the reference virtual scene includes a plurality of initial voxels, the scene space of the reference virtual scene includes a scene space in the reference virtual scene corresponding to each initial voxel.

In operation 1012, an initial camera location of an initial virtual camera in the reference virtual scene and a voxel location of each initial voxel in the reference virtual scene are obtained, and a distance between the initial camera location and each voxel location in the reference virtual scene is determined.

In some embodiments, the initial virtual camera in the reference virtual scene is configured to acquire picture information of the reference virtual scene at the initial camera location in the reference virtual scene, and the initial camera location is a scene location of the initial virtual camera in the reference virtual scene in the reference virtual scene.

In an example, an expression of the distance between the initial camera location and the voxel location may be:

$${L}_{1} = \sqrt{{( {x}_{1} - {x}_{2} )}^{2} + {( - {y}_{2} )}^{2} + {( {z}_{1} - {z}_{2} )}^{2}} \qquad ( 1 )$$

L₁ is configured for indicating the distance between the initial camera location and the voxel location. x₁ is configured for indicating an x-coordinate of the initial camera location. y₁ is configured for indicating a y-coordinate of the initial camera location. z₁ is configured for indicating a z-coordinate of the initial camera location. x₂ is configured for indicating an x-coordinate of the voxel location. y₂ is configured for indicating a y-coordinate of the voxel location. z₂ is configured for indicating a z-coordinate of the voxel location.

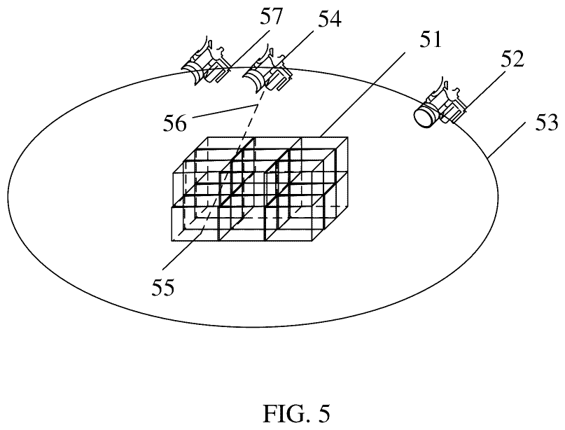

In an example, FIG. 5 is a schematic principle diagram of an initial voxel in a virtual picture generation method according to an embodiment of this disclosure. The reference virtual scene shown in FIG. 5 includes a plurality of initial voxels 51 (12 initial voxels are schematically shown in FIG. 5). A virtual camera moves on a camera running trajectory 53 in the reference virtual scene, to perform virtual scene shooting on the reference virtual scene from different angles. Each trajectory point on the camera running trajectory is at an equal distance to a central location of the reference virtual scene. An initial camera location 52 of the initial virtual camera in the reference virtual scene and a voxel location of each initial voxel 51 in the reference virtual scene are obtained. A distance between the initial camera location 52 and each voxel location 51 is determined.

In operation 1013, the size of each initial voxel in the reference virtual scene is adjusted based on the distance, to obtain the preset virtual scene.

In some embodiments, an adjusted size of the initial voxel is positively correlated with the corresponding distance. To be specific, a larger distance corresponds to a larger adjusted size of the initial voxel, and a smaller distance corresponds to a smaller adjusted size of the initial voxel.

In some embodiments, operation 1013 may be implemented in the following manner: obtaining a mapping relationship between a size of each voxel in the preset virtual scene and the distance between the initial camera location and each voxel location in the reference virtual scene; and performing the following processing for each initial voxel in the reference virtual scene, to obtain the preset virtual scene: determining a target size of the initial voxel based on the mapping relationship and the distance between the initial camera location and the voxel location corresponding to the initial voxel; and adjusting the size of the initial voxel in the reference virtual scene to the target size, to obtain a voxel corresponding to the initial voxel.

In some embodiments, the distance between the initial camera location and each voxel location in the reference virtual scene in the mapping relationship is positively correlated with the size of each voxel.

In some embodiments, the initial camera location and an orientation are set. The reference virtual scene is created, and an initial location and a size are allocated to each voxel in the scene. For each voxel in the reference virtual scene, a distance between the location of the voxel and the initial camera location is computed. The location of each voxel and the corresponding distance are stored. A mapping relationship function or a look-up table is defined based on the preset virtual scene. The function or the look-up table maps a voxel distance to a target voxel size. The mapping relationship may be based on a plurality of factors, such as a distance, importance, and visual importance. All the voxels in the reference virtual scene are traversed. For each voxel, a target size of the voxel is determined based on the computed camera distance and the defined mapping relationship. The size of each voxel in the reference virtual scene is adjusted by modifying a data structure of the voxel, or a new voxel is created to replace an original voxel. Size-adjusted voxels are combined into a new virtual scene, that is, the preset virtual scene.

In this way, a distance between a camera and a voxel is obtained, and a size of the voxel is adjusted based on a mapping relationship, so that a scene can be rendered more accurately, and a rendering result is closer to visual effects of a real world. The size of the voxel is allowed to be dynamically adjusted based on the location of the camera, so that scene rendering can a voxel size to be dynamically adjusted according to a camera location, so that scene rendering can be updated in real time based on a viewing angle of an observer, enhancing immersion and interactivity. The size of the voxel is adjusted, so that rendering performance can be optimized at different viewing distances. For voxels far away from the camera, details may be reduced, to reduce rendering costs. The mapping relationship of the size of the voxel is predefined, so that a target size of each voxel can be quickly determined in a rendering process, reducing a computation amount and improving rendering efficiency. A level of detail can be dynamically adjusted based on the distance from the camera, so that a nearby object is displayed at a higher level of detail, and a distant object is appropriately simplified, improving overall visual effects.

In some embodiments, the mapping relationship includes a plurality of index entries. The determining the size of each voxel in the preset virtual scene based on the mapping relationship and the distance between the initial camera location and each voxel location may be implemented in the following manner: for the distance corresponding to each voxel location, determining an index entry including the distance corresponding to the voxel location from the plurality of index entries of the mapping relationship as a target index entry, and determining a size in the target index entry as a size of a corresponding voxel.

In this way, the initial camera location of the initial virtual camera in the reference virtual scene and the voxel location of each initial voxel in the reference virtual scene are obtained, the distance between the initial camera location and each voxel location is determined, and the size of each initial voxel in the reference virtual scene is adjusted based on the distance, to obtain the preset virtual scene. Because the adjusted size of the initial voxel is positively correlated with the corresponding distance, a size of an initial voxel far away from the initial virtual camera is large, and a size of an initial voxel close to the initial virtual camera is small. Therefore, a voxel in the preset virtual scene that is closer to the initial virtual camera can cover more scene information of the initial virtual scene, scene precision of the voxel in the preset virtual scene that is closer to the initial virtual camera is higher, and scene precision of a voxel that is farther from the initial virtual camera is lower. Therefore, resource occupation of the preset virtual scene is effectively reduced, the obtained preset virtual scene better conforms to real visual effects, and resource utilization of the preset virtual scene is effectively improved.

In operation 102, for each voxel, rasterization is performed on the voxel in each normal direction of the voxel to obtain a voxel face element corresponding to each voxel face of the voxel.

In some embodiments, the voxel face element is configured for describing virtual scene information of the voxel in the corresponding normal direction, and the virtual scene information includes a scene face coordinate, a scene face color, a scene face normal, a scene face transformation matrix, and the like of the voxel.

In an example, when the voxel is a cubic voxel, the voxel includes a voxel face A, a voxel face B, a voxel face C, a voxel face D, a voxel face E, and a voxel face F. Rasterization is performed on the voxel in each normal direction of the voxel, to obtain voxel face elements respectively corresponding to the voxel face A, the voxel face B, the voxel face C, the voxel face D, the voxel face E, and the voxel face F.

In some embodiments, the preset virtual scene includes a plurality of virtual objects, and the virtual object includes a plurality of object points. The object point is a virtual scene point in the preset virtual scene that is located on the virtual object. The virtual object is a moving or static object in the virtual scene. A moving virtual object includes an animal, a vehicle, a person, and the like in the virtual scene. A static virtual object includes a wall, a stone, a ground, and the like in the virtual scene.

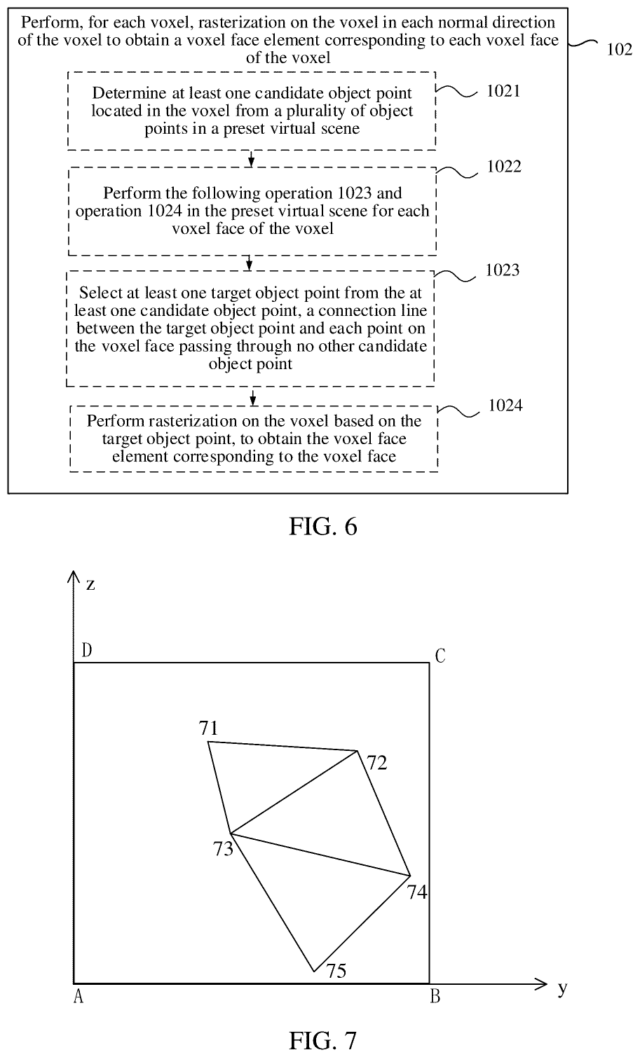

In some embodiments, FIG. 6 is a schematic flowchart of operation 1021 to operation 1024 in a virtual picture generation method according to an embodiment of this disclosure. Operation 102 shown in FIG. 3 may be implemented through operation 1021 to operation 1024 shown in FIG. 6.

In operation 1021, at least one candidate object point located in the voxel is determined from the plurality of object points in the preset virtual scene.

In some embodiments, the preset virtual scene includes the plurality of virtual objects, and the virtual object includes the plurality of object points. The object point is a virtual scene point in the preset virtual scene that is located on the virtual object. The virtual object includes the plurality of object points.

In some embodiments, operation 1021 may be implemented in the following manner: performing the following processing for each object point in the preset virtual scene: comparing a location of the object point with a location range of the voxel to obtain a comparison result, and determining the object point as a candidate object point when the comparison result indicates that the location of the object point is within the location range of the voxel.

In this way, the location of each object point in the preset virtual scene is compared with the location range of the voxel, and when the comparison result indicates that the location of the object point is within the location range of the voxel, the object point is determined as the candidate object point located in the voxel. Because the candidate object point located in the voxel can indicate a scene feature in the voxel, determining the candidate object point that is located in the voxel and that can accurately reflect the scene feature of the corresponding voxel ensures that the voxel face element of the voxel subsequently determined based on the candidate object point is more accurate.

In some embodiments, each voxel of the preset virtual scene includes at least one object point.

In operation 1022, the following operation 1023 and operation 1024 are performed in the preset virtual scene for each voxel face of the voxel.

In an example, when the voxel is a cubic voxel, the voxel includes a voxel face A, a voxel face B, a voxel face C, a voxel face D, a voxel face E, and a voxel face F. The following operation 1023 and operation 1024 are performed for each of the voxel face A, the voxel face B, the voxel face C, the voxel face D, the voxel face E, and the voxel face F of the voxel.

In operation 1023, at least one target object point is selected from the at least one candidate object point, a connection line between the target object point and each point on the voxel face passing through no other candidate object point.

Still in the foregoing example, when the candidate object point located in the voxel include a candidate object point Q1 and a candidate object point Q2, for the voxel face A of the voxel, at least one target object point corresponding to the voxel face A is selected from the candidate object point Q1 and the candidate object point Q2. When the target object point corresponding to the voxel face A is the candidate object point Q1, a connection line between the candidate object point Q1 and each point on the voxel face does not pass through the candidate object point Q2; or when the target object point corresponding to the voxel face A is the candidate object point Q2, a connection line between the candidate object point Q2 and each point on the voxel face does not pass through the candidate object point Q1.

In some embodiments, operation 1023 may be implemented in the following manner: determining, when there is one candidate object point located in the voxel, the candidate object point as the target object point; or performing, when there are a plurality of candidate object points located in the voxel, the following processing for each candidate object point: determining the candidate object point as a reference object point when a connection line between the candidate object point and each point on the voxel face passes through no other candidate object point; and determining a reference object point closest to the voxel face as the target object point.

In some embodiments, when the connection line between the candidate object point and each point on the voxel face passes through no other candidate object point, there is no other candidate object point in the voxel that forms an occlusion between the candidate object point and the voxel face, that is, there is no other candidate object point between the reference object point and the voxel face that forms an occlusion of any angle for the reference object point.

In some embodiments, for each voxel in the scene, all the candidate object points in the voxel are recognized and stored. For each voxel, a quantity of candidate object points in the voxel is computed. If there is one candidate object point in the voxel, the candidate object point is directly determined as the target object point. If there are a plurality of candidate object points in the voxel, the following operation is performed on each candidate object point: checking, for each candidate object point, whether a connection line between the candidate object point and each point on the voxel face passes through no other candidate object point. This is implemented by computing a distance between the connection line and another candidate object point. If the distance is greater than a threshold, it is considered that the connection line does not pass through the another candidate object point. If the connection line between the candidate object point and each point on the voxel face passes through no other candidate object point, the candidate object point is determined as a reference object point. A point closest to the voxel face is found from all reference object points, and is determined as the target object point.

In this way, the candidate object point in the voxel is selected as the target object point, so that an object location in the scene can be determined more precisely, improving accuracy of the entire scene. When there is only one candidate object point in the voxel, the candidate object point is directly determined as the target object point, so that misrecognition caused by noise or other interference factors can be effectively reduced. When a plurality of candidate object points is processed, only a reference object point whose connection line to the voxel face passes through no other candidate object point is considered, so that a computation amount for subsequent processing can be reduced, and performance can be optimized. A conflict or an overlap between object points can be avoided, and a target object point within each voxel is ensured to be unique, facilitating object segmentation and recognition. In a virtual reality or three-dimensional visual application, precisely recognizing a target object point can improve rendering visual effects and reduce visual distortion. When there are a plurality of candidate object points, a reference object point closest to the voxel face is selected as the target object point, so that a more complex decision-making process can be supported, such as path planning and collision detection. The candidate object point is screened and determined, so that robustness of the entire processing process is improved, and the processing process is insensitive to a small change in inputted data. The final target object point is selected, so that redundancy in scene data can be reduced, facilitating storage and transmission.

In some embodiments, the determining a reference object point closest to the voxel face as the target object point may be implemented in the following manner: when there is one reference object point, determining the reference object point as the target object point; or when there are a plurality of reference object points, determining a reference object point closest to the voxel face as the target object point.

In an example, FIG. 7 is a schematic principle diagram of a candidate object point in a virtual picture generation method according to an embodiment of this disclosure. The candidate object point located in the voxel includes a candidate object point 71, a candidate object point 72, a candidate object point 73, a candidate object point 74, and a candidate object point 75. When there are a plurality of candidate object points located in the voxel, the following processing is performed for each candidate object point: when a connection line between the candidate object point 71 and each point on a voxel face ABCD passes through no other candidate object point, determining the candidate object point as a reference object point; when a connection line between the candidate object point 72 and each point on the voxel face ABCD passes through no other candidate object point, determining the candidate object point 72 as a reference object point; when a connection line between the candidate object point 73 and each point on the voxel face ABCD passes through no other candidate object point, determining the candidate object point 73 as a reference object point; when a connection line between the candidate object point 74 and each point on the voxel face ABCD passes through no other candidate object point, determining the candidate object point 74 as a reference object point; when a connection line between the candidate object point 75 and each point on the voxel face ABCD passes through no other candidate object point, determining the candidate object point 75 as a reference object point; and determining a reference object point closest to the voxel face as the target object point.

In this way, when there are a plurality of candidate object points located in the voxel, and the connection line between the candidate object point and each point on the voxel face passes through no other candidate object point, the candidate object point is determined as a reference object point, and the reference object point closest to the voxel face is determined as the target object point, so that the determined target object point is an object point in the voxel that is closest to the voxel face and that is not occluded by another candidate object point. Therefore, the determined target object point can accurately reflect the scene feature of the corresponding voxel face, and the determined voxel face element is more accurate.

In some other embodiments, operation 1023 may alternatively be implemented in the following manner: determining, when there is one candidate object point located in the voxel, the candidate object point as the target object point; or determining, when there are a plurality of candidate object points located in the voxel, a candidate object point closest to the voxel face as the target object point.

In this way, when there are a plurality of candidate object points located in the voxel, and the object point closest to the voxel face is directly determined as the target object point, so that the determined target object point is an object point in the voxel that is closest to the voxel face. Therefore, the target object point that can accurately reflect the scene feature of the corresponding voxel face is determined most efficiently, and the determined voxel face element is more accurate.

In operation 1024, rasterization is performed on the voxel based on the target object point, to obtain the voxel face element corresponding to the voxel face.

In some embodiments, operation 1024 may be implemented in the following manner: obtaining vertex data of the target object point, the vertex data being configured for indicating a geometric primitive of the target object point in the preset virtual scene; and performing rasterization on the vertex data of the target object point in the voxel to obtain the voxel face element corresponding to the voxel face.

In some embodiments, rasterization is a process of converting vertex data into a fragment, functions to convert a graphic into an image including grids, and is characterized in that each element corresponds to one pixel in a frame buffer. Rasterization is the process of converting the vertex data into the fragment. Each element in the fragment corresponds to one pixel in the frame buffer. Rasterization is actually a process of converting a geometric primitive into a two-dimensional image. This process includes two parts of work: The first part of work is determining which integer grid regions in window coordinates are occupied by basic primitives. The second part of work is allocating one color value and one depth value to each region. The fragment is generated in the rasterization process. A process of converting a mathematical description of an object and color information related to the object into a pixel on a screen for a corresponding location and a color for filling the pixel is referred to as rasterization.

In some embodiments, the vertex data related to the determined target object point is obtained based on the determined target object point. The vertex data usually includes location coordinates, texture coordinates, a normal line, and the like of a vertex. The vertex data needs to define the geometric primitive, such as a triangle or a quadrangle, of the target object point in the preset virtual scene. Types and vertex orders of these primitives are determined for subsequent processing. An environment required for rasterization is set, including a projection matrix, a view matrix, a clipping plane, and the like. If necessary, an attribute, a texture, and the like of a material used in the rasterization process are set. The vertex data is transmitted to a rasterization stage. This process is usually completed by a graphics processing unit (GPU). In this operation, a vertex shader processes the vertex data, to convert the vertex data from a model space to a clipping space. A converted vertex is clipped, to remove a primitive not falling within a view frustum range. Then, the vertex is mapped to a screen space, and a location of the vertex on a screen is determined. The original geometric primitive (for example, the triangle) is assembled based on the location of the vertex on the screen. Each primitive is fragmented to generate fragments, each fragment corresponding to one pixel on the voxel face. A fragment shader program is executed for each fragment, which may include illumination computation, texture mapping, and the like. Final colors and depth values of the fragments are determined. A depth test is performed on the generated fragments to determine which fragments need to be rendered on the voxel face. Color values of the fragments are blended based on a result of the depth test, to obtain a final voxel face element. Converting processed segment data into the voxel face element may include setting vertex data, texture coordinates, a normal, and the like of the voxel face. The voxel face element is a voxelization result, and represents a face of the voxel in the three-dimensional space.

In this way, when there are a plurality of candidate object points located in the voxel, and the connection line between the candidate object point and each point on the voxel face passes through no other candidate object point, the candidate object point is determined as a reference object point, and the reference object point closest to the voxel face is determined as the target object point, so that the determined target object point is an object point in the voxel that is closest to the voxel face and that is not occluded by another candidate object point. Therefore, the determined target object point can accurately reflect the scene feature of the corresponding voxel face, and the determined voxel face element is more accurate.

In operation 103, a target voxel face element associated with a target virtual camera in the preset virtual scene is selected from the plurality of voxel face elements.

In some embodiments, the target voxel face element associated with the target virtual camera is a voxel face element in the preset virtual scene that can be acquired by the target virtual camera corresponding to the target virtual picture. In other words, the target voxel face element is a voxel face element visible in the target virtual camera.

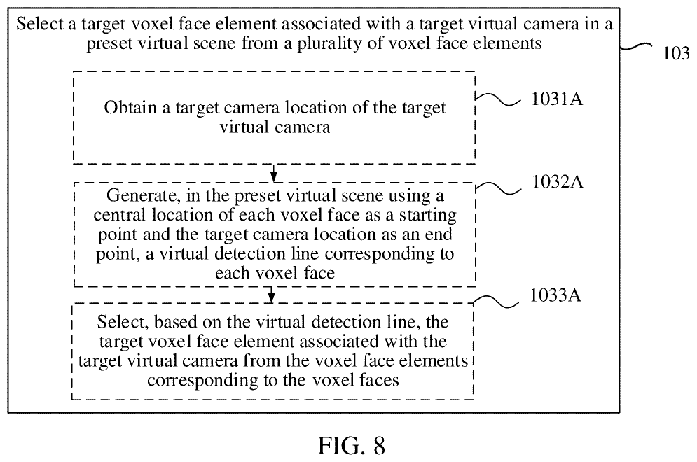

In some embodiments, FIG. 8 is a schematic flowchart of operation 1031A to operation 1033A in a virtual picture generation method according to an embodiment of this disclosure. Operation 103 shown in FIG. 3 may be implemented through operation 1031A to operation 1033A shown in FIG. 8.

In operation 1031A, a target camera location of the target virtual camera is obtained.

In some embodiments, the target virtual camera is configured to acquire picture information of a target virtual picture in the preset virtual scene.

In some embodiments, the target virtual camera and the initial virtual camera are virtual cameras that may be located at different virtual scene locations at different time points in the preset virtual scene.

In an example, refer to FIG. 5. A target camera location 54 of the target virtual camera in the preset virtual scene is obtained.

In operation 1032A, a virtual detection line corresponding to each voxel face is generated in the preset virtual scene using a central location of each voxel face as a starting point and the target camera location as an end point.

In some embodiments, detection information of the virtual detection line is configured for indicating whether the virtual detection line corresponding to the voxel face passes through another voxel face in the preset virtual scene.

In an example, refer to FIG. 5. A voxel face 55 is used as an example. A virtual detection line corresponding to the voxel face 55 is generated in the preset virtual scene using a central location of the voxel face 55 as a starting point and the target camera location 54 as an end point.

In operation 1033A, the target voxel face element associated with the target virtual camera is selected from the voxel face elements corresponding to the voxel faces based on the virtual detection line.

In some embodiments, operation 1033A may be implemented by performing the following processing for the voxel face element corresponding to each voxel face: determining, in the preset virtual scene, the detection information of the virtual detection line corresponding to the voxel face; and determining the voxel face element as the target voxel face element when the detection information indicates that the virtual detection line corresponding to the voxel face passes through no other voxel face in the preset virtual scene.

In some embodiments, when the detection information indicates that the virtual detection line corresponding to the voxel face passes through another voxel face in the preset virtual scene, the voxel face element is not determined as the target voxel face element.

In an example, refer to FIG. 5. The voxel face 55 is used as an example. Detection information of a virtual detection line 56 corresponding to the voxel face 55 is determined in the preset virtual scene. When the detection information indicates that the virtual detection line 56 corresponding to the voxel face 55 passes through no other voxel face in the preset virtual scene, the voxel face element is determined as the target voxel face element.

In this way, more accurate scene analysis and object detection can be implemented by determining, in the preset virtual scene, the detection information of the virtual detection line corresponding to the voxel face. When the detection information indicates that the virtual detection line passes through no other voxel face in the scene, a possibility of misrecognition or overlapping of an object can be eliminated, improving accuracy of scene understanding. Determining the voxel face element as the target voxel face element can help optimize a data structure, so that subsequent processing is more efficient. The target voxel face element is recognized, so that unnecessary rendering computation can be reduced, and only a key face element is rendered, improving rendering efficiency. Excluding a non-target voxel face element can make the scene more clearly visualized and reduce visual clutter. Only a virtual detection line that does not intersect another voxel face is processed, so that unnecessary computation is reduced, and an overall processing speed is improved. In a game or simulation environment, reducing a quantity of geometric bodies that need to be rendered can significantly improve performance, and ensure smooth user experience.

In this way, when the detection information of the virtual detection line indicates that the virtual detection line corresponding to the voxel face passes through no other voxel face in the preset virtual scene, there is no occlusion between the target virtual camera and the voxel face in the preset virtual scene. In other words, the target virtual camera corresponding to the target virtual picture in the preset virtual scene can acquire the voxel face element. In this case, the voxel face element is determined as the target voxel face element, to subsequently perform picture shading on the preset virtual scene based on the target voxel face element, to obtain the target virtual picture. Therefore, participation of a voxel face element other than the target voxel face element in a picture shading computation process is avoided, and picture shading efficiency is effectively improved.

In some embodiments, before operation 103 is performed, the following processing may be performed: obtaining the picture information of the target virtual picture.

In some embodiments, the picture information is configured for indicating whether the target virtual picture is a first video frame of a video corresponding to the preset virtual scene, and the first video frame is a video frame of the video corresponding to the preset virtual scene whose play time is the earliest.

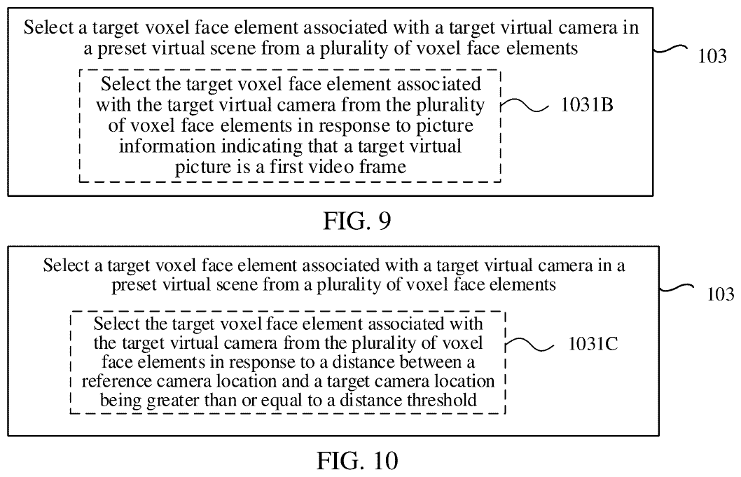

In some embodiments, FIG. 9 is a schematic flowchart of operation 1031B in a virtual picture generation method according to an embodiment of this disclosure. Operation 103 shown in FIG. 3 may be implemented through operation 1031B shown in FIG. 9.

In operation 1031B, the target voxel face element associated with the target virtual camera is selected from the plurality of voxel face elements in response to the picture information indicating that the target virtual picture is the first video frame.

In some embodiments, when the picture information indicates that the target virtual picture is the first video frame, because there is no video frame whose play time is earlier than that of the target virtual picture, the target virtual picture cannot be generated using the video frame whose play time is earlier. Therefore, the target voxel face element associated with the target virtual camera is selected from the plurality of voxel face elements, to generate the target virtual picture using the target voxel face element.

In some embodiments, after the picture information of the target virtual picture is obtained, the following processing may be performed: obtaining a reference virtual picture of the video in response to the picture information indicating that the target virtual picture is not the first video frame; and obtaining a reference camera location of a reference virtual camera in the preset virtual scene and the target camera location of the target virtual camera in the preset virtual scene.

In some embodiments, the reference virtual camera is configured to acquire picture information of the reference virtual picture in the preset virtual scene, and the target virtual camera is configured to acquire the picture information of the target virtual picture in the preset virtual scene.

In some embodiments, the target virtual camera, the initial virtual camera, and the reference virtual camera are virtual cameras that may be located at different virtual scene locations at different time points in the preset virtual scene.

In an example, refer to FIG. 5. A reference camera location 57 of the reference virtual camera in the preset virtual scene and the target camera location 54 of the target virtual camera in the preset virtual scene are obtained.

In some embodiments, the reference virtual picture is a previous frame of virtual picture of the target virtual picture in the video.

In an example, the video includes a video frame A, a video frame B, and a video frame C in chronological order of play time. In this case, when the target virtual picture is the video frame B, the corresponding reference virtual picture is the video frame A.

In some embodiments, FIG. 10 is a schematic flowchart of operation 1031C in a virtual picture generation method according to an embodiment of this disclosure. Operation 103 shown in FIG. 3 may be implemented through operation 1031C shown in FIG. 10.

In operation 1031C, the target voxel face element associated with the target virtual camera are selected from the plurality of voxel face elements in response to a distance between the reference camera location and the target camera location being greater than or equal to a distance threshold.

In some embodiments, when the distance between the reference camera location and the target camera location is greater than or equal to the distance threshold, there is a large deviation between shooting angles for the preset virtual scene at the reference camera location and the target camera location. In other words, there is a large difference between pictures of the preset virtual scene acquired by the reference virtual camera and the target virtual camera. In this case, the reference virtual picture cannot be reused as the target virtual picture. Therefore, the target voxel face element associated with the target virtual camera may be selected from the plurality of voxel face elements, to determine the corresponding target virtual picture based on the target voxel face element.

In this way, whether a current video frame is the first frame is checked, so that visual consistency between video frames can be ensured, and an abrupt picture transition can be avoided. The locations of the reference virtual camera and the target virtual camera are obtained, helping keep scene continuity, so that a user feels a smooth transition when watching the video. The target voxel face element is dynamically selected based on the distance between the reference camera location and the target camera location, so that scene rendering is more flexible and adapts to changes. If the target virtual picture is not the first video frame, computation does not need to be performed again for the entire scene, so that computing resources can be saved. Only the voxel face element associated with the target virtual camera is processed, so that a rendering load is reduced, and the rendering efficiency is improved. The voxel face element most correlated with the target virtual camera is selected, so that a rendering result can be optimized to provide clearer visual effects. A difference between the reference camera location and the target camera location is allowed, to support movements and dynamic changes of the camera in the scene.

In some embodiments, after the reference camera location of the reference virtual camera in the preset virtual scene and the target camera location of the target virtual camera in the preset virtual scene are obtained, the reference virtual picture is determined as the target virtual picture in response to the distance between the reference camera location and the target camera location being less than the distance threshold.

In some embodiments, when the distance between the reference camera location and the target camera location is less than the distance threshold, there is a small deviation between the shooting angles for the preset virtual scene at the reference camera location and the target camera location. In other words, there is a small difference between the pictures of the preset virtual scene acquired by the reference virtual camera and the target virtual camera. In this case, the reference virtual picture may be reused as the target virtual picture. Therefore, the reference virtual picture is directly determined as the target virtual picture.

In this way, when the picture information indicates that the target virtual picture is not the first video frame of the video, and the distance between the reference camera location and the target camera location is less than the distance threshold, there is a small deviation between the shooting angles for the preset virtual scene at the reference camera location and the target camera location, and the reference virtual picture is directly determined as the target virtual picture. In this way, the reference virtual picture is reused as the target virtual picture, effectively reducing a time length for generating the target virtual picture and effectively improving efficiency of generating the target virtual picture.

In operation 104, picture shading is performed on the preset virtual scene based on the target voxel face element, to obtain the target virtual picture.

In some embodiments, the target voxel face element includes a plurality of face element points, and the face element point is a basic unit constituting the target voxel face element.

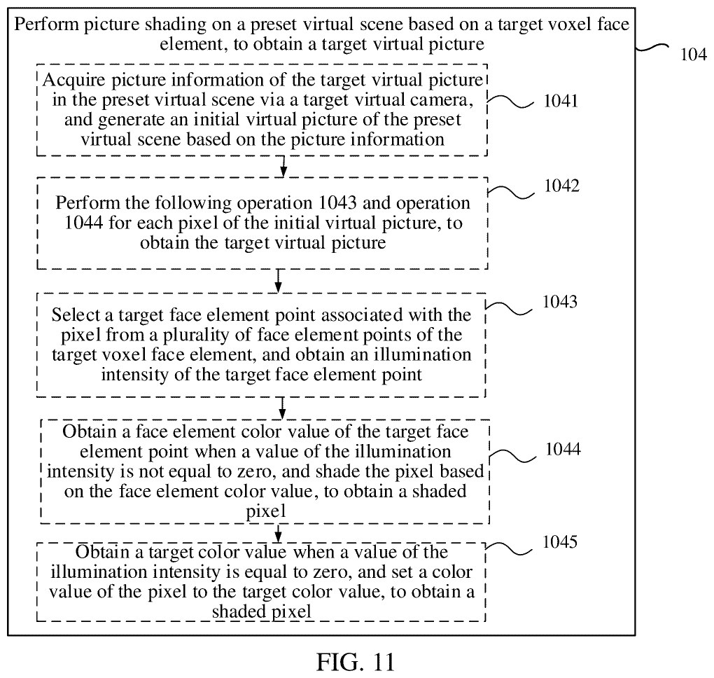

In some embodiments, FIG. 11 is a schematic flowchart of operation 1041 to operation 1045 in a virtual picture generation method according to an embodiment of this disclosure. Operation 104 shown in FIG. 3 may be implemented through operation 1041 to operation 1045 shown in FIG. 11.

In operation 1041, the picture information of the target virtual picture is acquired in the preset virtual scene via the target virtual camera, and an initial virtual picture of the preset virtual scene is generated based on the picture information.

In some embodiments, a pixel of the initial virtual picture is in one-to-one correspondence with a pixel of the target virtual picture, and for each pixel of the initial virtual picture, there is a corresponding pixel of the target virtual picture. For example, if an image needs to be scaled during image processing, each pixel of the initial image is mapped to a new pixel of a scaled image, keeping a direct relationship between an original pixel and a scaled pixel. Such a mapping relationship enables an image processing algorithm to more accurately control visual output of the image.

In some embodiments, the picture information is configured for indicating virtual scene information of the preset virtual scene that can be acquired by the target virtual camera, and the virtual scene information includes a color, texture, and the like of a corresponding virtual scene element.

In some embodiments, the picture information includes sub-picture information in one-to-one correspondence with the pixel of the initial virtual picture. The generating an initial virtual picture of the preset virtual scene based on the picture information may be implemented in the following manner: for each piece of sub-picture information, determining the sub-picture information as pixel information of a corresponding pixel, and performing pixel stitching on the pixel information of the pixel to obtain the initial virtual picture of the preset virtual scene.

In some embodiments, pixel stitching is a processing process of stitching pixels according to a corresponding distribution rule in the preset virtual scene, to obtain a virtual picture. A distribution rule of pixels of the virtual picture satisfies the corresponding distribution rule in the preset virtual scene.

In operation 1042, the following operation 1043 and operation 1044 are performed for each pixel of the initial virtual picture, to obtain the target virtual picture.

In an example, the initial virtual picture includes a pixel A, a pixel B, and a pixel C. The following operation 1043 to operation 1044 are performed for each of the pixel A, the pixel B, and the pixel C of the initial virtual picture, to obtain the target virtual picture.

In operation 1043, a target face element point associated with the pixel is selected from the plurality of face element points of the target voxel face element, and an illumination intensity of the target face element point is obtained.

In some embodiments, the target face element point associated with the pixel is a face element point on a connection line between the pixel and the target camera location. In other words, the target face element point is acquired by the target virtual camera at the target camera location and imaged on the corresponding pixel.

In some embodiments, the selecting a target face element point associated with the pixel from the plurality of face element points of the target voxel face element in operation 1043 may be implemented in the following manner: obtaining the target camera location of the target virtual camera in the preset virtual scene, and generating, in the preset virtual scene using the pixel as a starting point and the target camera location as an end point, a virtual detection line corresponding to the pixel; and determining, for each face element point, the face element point as the target face element point when the virtual detection line corresponding to the pixel passes through the face element point.

In some embodiments, when the virtual detection line corresponding to the pixel does not pass through the face element point, the face element point is not determined as the target face element point.

In some embodiments, the virtual detection line may alternatively be an extension line of a line segment that uses the pixel as a starting point and the target camera location as an end point.

In some embodiments, location information of the target virtual camera is obtained from the preset virtual scene, and usually includes three-dimensional coordinates of the camera. For each pixel, a virtual detection line is generated from the pixel to the location of the target virtual camera using a ray or a similar algorithm. This line may be considered as a ray, and extends from the pixel to the camera location in the three-dimensional space. All face element points (points on the voxel face element) in the preset virtual scene are traversed. For each face element point, whether the previously generated virtual detection line passes through the point is checked. If the virtual detection line passes through a face element point, the face element point is marked as a target face element point.

In operation 1044, a face element color value of the target face element point is obtained when a value of the illumination intensity is not equal to zero, and the pixel is shaded based on the face element color value, to obtain a shaded pixel.

In some embodiments, when the illumination intensity is not equal to zero, the target face element point can be imaged on the corresponding pixel. In this case, the pixel may be shaded based on the face element color value of the target face element point, to obtain the shaded pixel.

In some embodiments, the shading the pixel based on the face element color value, to obtain a shaded pixel in operation 1044 may be implemented in the following manner: obtaining a plurality of illumination intensity-adjustment coefficient index entries, and determining a target index entry including the illumination intensity of the target face element point from the plurality of illumination intensity-adjustment coefficient index entries; determining an adjustment coefficient in the target index entry as a target adjustment coefficient of the pixel; and determining a product of the face element color value and the target adjustment coefficient as a reference color value, and setting the color value of the pixel to the reference color value, to obtain the shaded pixel.

In some embodiments, the illumination intensity is negatively correlated with the adjustment coefficient. In other words, a larger illumination intensity corresponds to a smaller adjustment coefficient, so that the reference color value corresponding to a product value of the face element color value and the target adjustment coefficient is smaller, making the reference color value brighter. A smaller illumination intensity corresponds to a larger adjustment coefficient, so that the reference color value corresponding to the product value of the face element color value and the target adjustment coefficient is larger, making the reference color value darker.

In this way, the face element color value is adjusted based on the illumination intensity and the target adjustment coefficient of the target face element point, and the pixel is shaded using the obtained reference color value, so that a color presented by the shaded pixel can more accurately reflect a color of the target face element point in the preset virtual scene, effectively improving presentation effects of the target virtual picture.

In operation 1045, a target color value is obtained when a value of the illumination intensity is equal to zero, and a color value of the pixel is set to the target color value, to obtain a shaded pixel.

In some embodiments, the target color value is different from the face element color value, and the target color value is configured for indicating that the pixel is invisible in the target virtual picture.

In an example, when the color value is represented by a red, green, and blue (RGB) value, the target color value may be (0, 0, 0). In conventional visual effects, when the illumination intensity is equal to zero, the color usually appears black, to indicate invisible effects in the picture.

In this way, the preset virtual scene is obtained, and rasterization is performed for each voxel in the preset virtual scene to obtain the voxel face elements corresponding to the voxel. In this way, all voxel face elements in the preset virtual scene are obtained. For any frame of target virtual picture of the preset virtual scene, a target voxel face element associated with the target virtual camera is directly selected from the plurality of voxel face elements, to obtain the target virtual picture. In this way, even if there may be a voxel overlap between different virtual pictures, because all the voxel face elements in the preset virtual scene have been determined in advance, the target virtual picture can be generated by directly selecting the target voxel face element associated with the target virtual camera from the plurality of voxel face elements, without performing a same processing process on a duplicate voxel between different picture frames. Therefore, virtual picture generation efficiency is effectively improved.

The following describes an exemplary application of this embodiment of this disclosure in an actual application scenario of virtual scene rendering.

A global illumination technology remains an emphasis and difficulty in the field of computer graphics. Currently, there are some technical applications at a personal computer (PC) side. However, due to performance limitations, there is no mature solution at a mobile side in the field of global illumination. In this embodiment of this disclosure, extensive modifications are made on a surface finite element global illumination algorithm for the PC side, to optimize performance, so that a stable real-time global illumination requirement can be met at the mobile side.

In terms of face element generation, voxelization and rasterization are combined. In a vertex shading process, each grid vertex in a scene is traversed in three directions of X, Y, and Z axes, to find a vertex closest to a current plane, and key information such as world space coordinates, a normal line, and a color is stored. In a face element generation process, the information may be directly read to generate all face elements in a global scope at a time, avoiding problems caused by generation from a screen space in each frame in a conventional solution, such as high performance overheads, slow convergence of the scene, and incapability of controlling a generation density using geometric information of an object, and achieving good anisotropy. In a voxelization process, a farther distance from a camera indicates higher sparsity of generated face elements, so that performance overheads are further reduced. In a final illumination acquisition process, for an illumination acquisition point in the screen space, in this embodiment of this disclosure, a scene rendering result of a previous frame is reused, so that a quantity of times of traversing a face element cache is reduced, information is added, and performance is further improved.

In this embodiment of this disclosure, voxelization is first performed on the scene to establish a grid coordinate system (as long as a grid resolution can cover the entire scene). Specifically, a 3D discrete space Z3 may be represented as a set of grid points in a 3D space, and any point P in the discrete space may be represented by Cartesian coordinates P (x, y, z) of the point. A grid space is one type of discrete space. In this embodiment of this disclosure, the grid space N3 is established using a bounding box covering the entire scene. The entire space is divided into N*N*N grids based on a resolution N, and a length Cellₓ of each grid in x direction, a length Cell_{y} of each grid in the y direction, and a length Cell_{z} of each grid in the z direction may be calculated according to the following formula, where L represents a length of the entire bounding box in a direction.

$${Cell}_{x} = \frac{{L}_{x}}{N} , {Cell}_{y} = \frac{{L}_{y}}{N} , {Cell}_{z} = \frac{{L}_{z}}{N} \qquad ( 2 )$$

Lₓ is configured for indicating a length of the bounding box in the x direction. L_{y} is configured for indicating a length of the bounding box in the y direction. L_{z} is configured for indicating a length of the bounding box in the z direction.

With the concept of the grid coordinate system, in this embodiment of this disclosure, coordinates of any point in a world space may be mapped to the grid coordinate system. For example, coordinates of the any point are (X₀, Y₀, Z₀). If the grid coordinate system is established only in a first quadrant, a corresponding grid coordinate system (X, Y, Z) may be simply represented as:

$$X = \frac{{X}_{0}}{{Cell}_{x}} , Y = \frac{{Y}_{0}}{{Cell}_{y}} , Z = \frac{{Z}_{0}}{{Cell}_{z}} \qquad ( 3 )$$

Cellₓ is configured for indicating the length of each grid in the x direction. Cell_{y} is configured for indicating the length of each grid in the y direction. Cell_{z} is configured for indicating the length of each grid in the y direction.

Depth occlusion culling is an acceleration structure of a conventional rasterization pipeline, performs rasterization on only a grid visible at a current viewing angle, and is turned on by default. Because all grid vertexes in the scene need to be traversed in this embodiment of this application, r.AllowOcclusionQueries=True is set in a configuration file to turn off culling.

In the rasterization pipeline, processing is performed in three directions X, Y, and Z of the grid coordinate system, that is, rasterization is performed in the three directions for three times, where projection surfaces and resolutions correspond to grid coordinate systems of the directions. In addition, because a voxel is a cube with six planes, in this embodiment of this disclosure, six texture maps are enabled to respectively record information in six directions: X, Y, Z, −X, −Y, and −Z. For example, in a positive direction of the X axis, rasterization is performed with a YZ plane as a projection surface. In this embodiment of this disclosure, information may be stored in a texture in the X direction or the −X direction based on front/back face information of the selected grid vertex. Therefore, two textures are needed in each direction, and a total of six textures are needed.

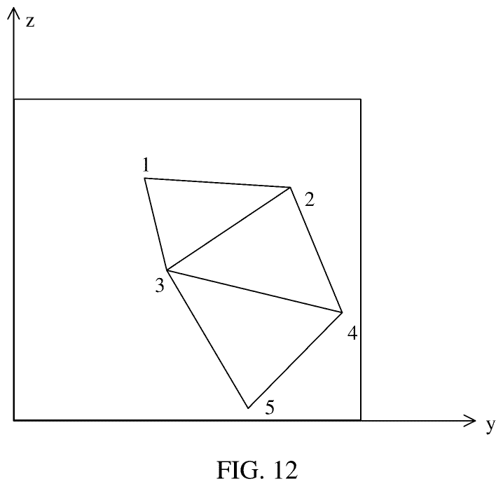

In some embodiments, FIG. 12 is a schematic principle diagram of a voxel in a virtual picture generation method according to an embodiment of this disclosure. FIG. 12 is described by using an example in which the positive direction of the x axis points outward from a screen. FIG. 12 shows a rasterization situation of a voxel in a direction in which the positive direction of the x axis points outward from the screen. In a rasterization procedure, a vertex shader first traverses vertexes (for example, a vertex 1, a vertex 2, a vertex 3, a vertex 4, and a vertex 5 shown in FIG. 12) of each grid, and transmits data (for example, coordinates, colors, normals, and transformation matrices) of the grid vertexes to a pixel shader. FIG. 12 shows five vertexes (the vertex 1, the vertex 2, the vertex 3, the vertex 4, and the vertex 5) transmitted by the vertex shader to the pixel shader, indicating that there are five vertexes in this direction falling within a range of this voxel. In this embodiment of this disclosure, locations of the five vertexes are traversed in a pipelined manner. Starting from the vertex 1 to the vertex 5, for example, for the vertex 1, in this embodiment of this disclosure, the vertex shader obtains a front/back face attribute of the vertex 1. If the vertex 1 is on a front face, vertex coordinates of the vertex 1 are divided by a side length of the voxel to obtain a division result, a fractional part of the division result is extracted to obtain a relative offset of the vertex 1 in the voxel, and a difference between an x component of the relative offset and 1 is determined as a target distance of the vertex 1 relative to a positive x face; or if the vertex 1 is on a back face, vertex coordinates of the vertex 1 are divided by a side length of the voxel to obtain a division result, a fractional part of the division result is extracted to obtain a relative offset of the vertex 1 in the voxel, and an x component of the relative offset is determined as a target distance of the vertex 1 relative to a negative x face. A currently stored minimum distance is obtained, and the minimum distance is compared with the target distance corresponding to the vertex 1, to obtain a comparison result. When the comparison result indicates that the target distance is less than the minimum distance, an attribute of the vertex 1 is written to a map in a corresponding direction, and the minimum distance is updated. In this embodiment of this disclosure, information such as a location, a normal, an albedo, a primID, and Emissive of the vertex 1 is stored in the map in a corresponding x direction. If the vertex 1 is on a reverse side, the information is stored in a map in a negative direction of X. If the vertex 1 is on the front face, the information is stored in a map in the positive direction of X. In this way, after rasterization in the three directions, information about a vertex in each voxel that is closest to each voxel face is stored in the maps in the six directions. In a face element generation process, data may be directly obtained from the maps at a time.

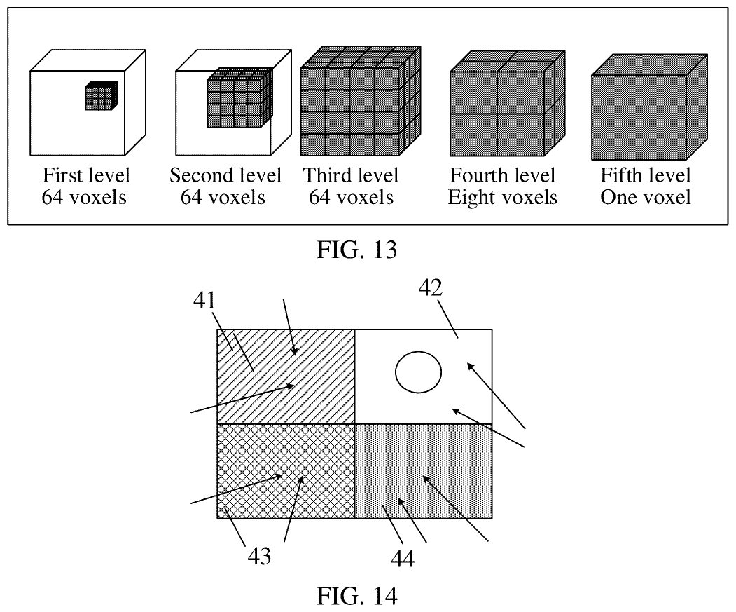

In some embodiments, FIG. 13 is a schematic principle diagram of voxelization in a virtual picture generation method according to an embodiment of this disclosure. Because a length, a width, and a height of each grid in the grid coordinate system may be set freely, in this embodiment of this disclosure, voxelization is performed using a plurality of levels of grids. In this embodiment of this disclosure, it is set that a first-level grid is within 50 m away from the camera and has highest precision, each having a size of 2*2*2; a second-level grid is 50 m to 250 m away from the camera, each having a size of 4*4*4; and a third-level grid is from a location 250 m away from the camera to a boundary of the grid coordinate system, each having a size of 8*8*8. A voxel closer to the camera has a smaller radius, a voxel farther from the camera has a larger radius. In this way, effects of high precision at a near location and low precision at a far location are achieved. Refer to FIG. 13. Each of the first-level grid, the second-level grid, and the third-level grid includes 64 voxels, a fourth-level grid may include eight voxels, and a fifth-level grid may include one voxel. In addition, a size of the voxel in the first-level grid is smaller than that in the second-level grid, the size of the voxel in the second-level grid is smaller than that in the third-level grid, and the size of the voxel in the fourth-level grid is smaller than that in the fifth-level grid.

In some embodiments, FIG. 14 is a schematic principle diagram of a face element in a virtual picture generation method according to an embodiment of this disclosure. In this embodiment of this disclosure, a rendering result of a previous frame is reused and introduced into finite element global illumination (GI), and software ray tracing may return coordinates of a location of a ray hit point. In a conventional solution, face elements around the location are traversed, and a weighted average of illumination information is used as a color of this point. This solution in which color information is entirely obtained from the face elements is limited. Because a representation of the scene is discretized, some high-precision scene information cannot be obtained. For example, for the foregoing planes of four colors (referring to FIG. 14, a plane 41 of a color A, a plane 42 of a color B, a plane 43 of a color C, and a plane 44 of a color D), only one color can be obtained as a final color. Therefore, for a ray whose ray hit point is within the screen, in this embodiment of this disclosure, a value x between 0 and 1 is set: the ray has a probability of x to average the face elements according to the conventional solution, and has a probability of (1-x) to reuse the rendering result of the previous frame. A final color of the pixel in the previous frame is read as a color returned by the ray. Rays are cast in each frame in large quantities and random directions. A large quantity of rays are cast onto the plane, and some rays directly use the color of this point as a return value. In this way, the problem of information loss caused by scene discretization is greatly alleviated.

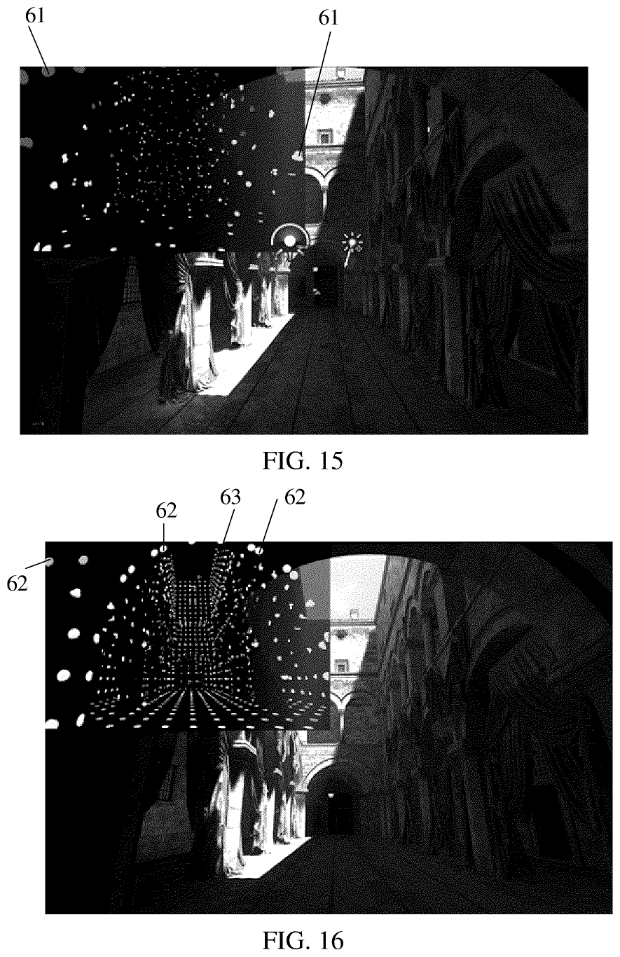

In some embodiments, FIG. 15 is a schematic diagram of effects of a first virtual picture according to the related art. As shown in FIG. 15, distribution of face elements 61 in a screen space of a virtual picture presents a disordered distribution situation. FIG. 16 is a schematic diagram of effects of a virtual picture according to an embodiment of this disclosure. A face element 62 close to a virtual camera has a large size, and a face element 63 far from the virtual camera has a small size. This presents a negative correlation between a size of a face element and a distance to the virtual camera.

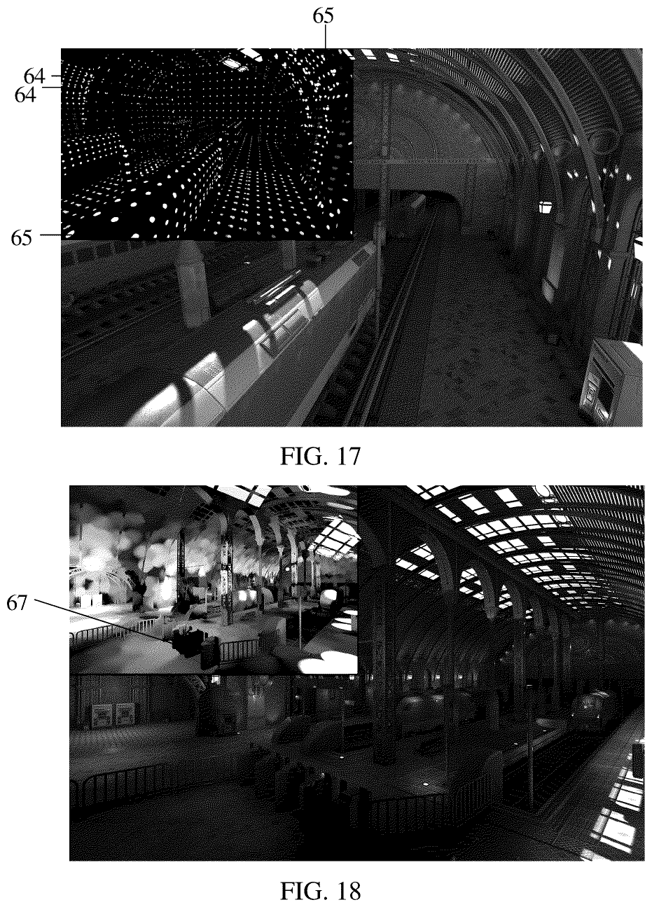

In some embodiments, FIG. 17 is a schematic diagram of effects of a second virtual picture according to the related art. A face element 65 close to a virtual camera has a large size, and a face element 64 far from the virtual camera has a small size. This presents a negative correlation between a size of a face element and a distance to the virtual camera. In addition, the face element 64 and the face element 65 are distributed orderly, which makes the distribution more ordered than the face element distribution in FIG. 16.

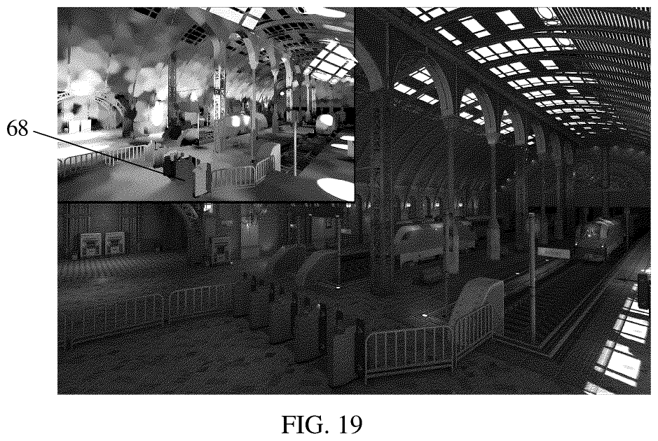

In some embodiments, FIG. 18 is a schematic diagram of effects of a face element illumination cache according to the related art. FIG. 19 is a schematic diagram of effects of a face element illumination cache according to an embodiment of this disclosure. It can be observed that compared with those in the related art, the effects of the face element illumination cache provided in this embodiment of this disclosure has more detailed information, few black speckles, and converges more rapidly. Referring to FIG. 18, the face element illumination cache in the related art has a black speckle at a virtual scene location 67. Referring to FIG. 19, there is no black speckle at a corresponding virtual scene location 68 in the effects of the face element illumination cache provided in this embodiment of this disclosure.

In this way, the preset virtual scene is obtained, and rasterization is performed for each voxel in the preset virtual scene to obtain the voxel face elements corresponding to the voxel. In this way, all voxel face elements in the preset virtual scene are obtained. For any frame of target virtual picture of the preset virtual scene, a target voxel face element associated with the target virtual camera is directly selected from the plurality of voxel face elements, to obtain the target virtual picture. In this way, even if there may be a voxel overlap between different virtual pictures, because all the voxel face elements in the preset virtual scene have been determined in advance, the target virtual picture can be generated by directly selecting the target voxel face element associated with the target virtual camera from the plurality of voxel face elements, without performing a same processing process on a duplicate voxel between different picture frames. Therefore, virtual picture generation efficiency is effectively improved.

Relevant data such as the preset virtual scene is involved in the embodiments of this disclosure. When the embodiments of this disclosure are applied to a specific product or technology, a license or consent of a user is required to be obtained, and collection, use, and processing of the related data are required to comply with related laws and regulations and standards of related countries and regions.

The following continues to describe an exemplary structure in which the virtual picture generation apparatus 455 provided in the embodiments of this disclosure is implemented as the software modules. In some embodiments, as shown in FIG. 2, the software modules in the virtual picture generation apparatus 455 stored in the memory 450 may include: the obtaining module 4551, configured to obtain a preset virtual scene, the preset virtual scene including a plurality of voxels, and the voxel including a plurality of voxel faces having different normal directions; the rasterization module 4552, configured to perform, for each voxel, rasterization on the voxel in each normal direction of the voxel to obtain a voxel face element corresponding to each voxel face of the voxel, the voxel face element being configured for describing virtual scene information of the voxel in the corresponding normal direction; the selection module 4553, configured to select a target voxel face element associated with a target virtual camera in the preset virtual scene from the plurality of voxel face elements; and the picture shading module 4554, configured to perform picture shading on the preset virtual scene based on the target voxel face element, to obtain a target virtual picture.

In some embodiments, the obtaining module is further configured to: obtain an initial virtual scene, and perform voxelization on the initial virtual scene to obtain a reference virtual scene including a target quantity of initial voxels; obtain an initial camera location of an initial virtual camera in the reference virtual scene and a voxel location of each initial voxel in the reference virtual scene; and determine a distance between the initial camera location and each voxel location in the reference virtual scene, and adjust a size of each initial voxel in the reference virtual scene based on the distance, to obtain the preset virtual scene.

In some embodiments, the obtaining module is further configured to: obtain a mapping relationship between a size of each voxel in the preset virtual scene and the distance between the initial camera location and each voxel location in the reference virtual scene, the distance between the initial camera location and each voxel location in the reference virtual scene in the mapping relationship being positively correlated with the size of each voxel; and perform the following processing for each initial voxel in the reference virtual scene, to obtain the preset virtual scene: determining a target size of the initial voxel based on the mapping relationship and the distance between the initial camera location and the voxel location corresponding to the initial voxel; and adjusting the size of the initial voxel in the reference virtual scene to the target size, to obtain a voxel corresponding to the initial voxel.

In some embodiments, the preset virtual scene includes a plurality of virtual objects, and the virtual object includes a plurality of object points. The rasterization module is further configured to: determine at least one candidate object point located in the voxel from the plurality of object points in the preset virtual scene; and perform the following processing in the preset virtual scene for each voxel face of the voxel: selecting at least one target object point from the at least one candidate object point, a connection line between the target object point and each point on the voxel face passing through no other candidate object point; and performing rasterization on the voxel based on the target object point, to obtain the voxel face element corresponding to the voxel face.

In some embodiments, the rasterization module is further configured to: determine, when there is one candidate object point located in the voxel, the candidate object point as the target object point; or perform, when there are a plurality of candidate object points located in the voxel, the following processing for each candidate object point: determining the candidate object point as a reference object point when a connection line between the candidate object point and each point on the voxel face passes through no other candidate object point; and determining a reference object point closest to the voxel face as the target object point.

In some embodiments, the selection module is further configured to: obtain a target camera location of the target virtual camera in the preset virtual scene, the target virtual camera being configured to acquire picture information of the target virtual picture in the preset virtual scene; generate, in the preset virtual scene using a central location of each voxel face as a starting point and the target camera location as an end point, a virtual detection line corresponding to each voxel face; and select, based on the virtual detection line, the target voxel face element associated with the target virtual camera from the voxel face elements corresponding to the voxel faces.

In some embodiments, the selection module is further configured to perform the following processing for the voxel face element corresponding to each voxel face: determining, in the preset virtual scene, detection information of the virtual detection line corresponding to the voxel face; and determining the voxel face element as the target voxel face element when the detection information indicates that the virtual detection line corresponding to the voxel face passes through no other voxel face in the preset virtual scene.

In some embodiments, the virtual picture generation apparatus further includes an information obtaining module, configured to obtain the picture information of the target virtual picture, the picture information being configured for indicating whether the target virtual picture is a first video frame of a video corresponding to the preset virtual scene. The selection module is further configured to select the target voxel face element associated with the target virtual camera from the plurality of voxel face elements in response to the picture information indicating that the target virtual picture is the first video frame.

In some embodiments, the virtual picture generation apparatus further includes a location obtaining module, configured to: obtain a reference virtual picture in the video in response to the picture information indicating that the target virtual picture is not the first video frame, the reference virtual picture being a previous frame of virtual picture of the target virtual picture in the video; and obtain a reference camera location of a reference virtual camera in the preset virtual scene and the target camera location of the target virtual camera in the preset virtual scene, the reference virtual camera being configured to acquire picture information of the reference virtual picture in the preset virtual scene, and the target virtual camera being configured to acquire the picture information of the target virtual picture in the preset virtual scene. The selection module is further configured to select the target voxel face element associated with the target virtual camera from the plurality of voxel face elements in response to a distance between the reference camera location and the target camera location being greater than or equal to a distance threshold.

In some embodiments, the virtual picture generation apparatus further includes a determining module, configured to determine the reference virtual picture as the target virtual picture in response to the distance between the reference camera location and the target camera location being less than the distance threshold.

In some embodiments, the picture shading module is further configured to: acquire the picture information of the target virtual picture in the preset virtual scene via the target virtual camera, and generate an initial virtual picture of the preset virtual scene based on the picture information, a pixel of the initial virtual picture being in one-to-one correspondence with a pixel of the target virtual picture; and perform the following processing for each pixel of the initial virtual picture to obtain the target virtual picture: selecting a target face element point associated with the pixel from the plurality of face element points of the target voxel face element, and obtaining an illumination intensity of the target face element point; and obtaining a face element color value of the target face element point when a value of the illumination intensity is not equal to zero, and shading the pixel based on the face element color value, to obtain a shaded pixel; or obtaining a target color value when a value of the illumination intensity is equal to zero, and setting a color value of the pixel to the target color value, to obtain a shaded pixel, the target color value being different from the face element color value.

In some embodiments, the picture shading module is further configured to: obtain the target camera location of the target virtual camera in the preset virtual scene, and generate, in the preset virtual scene using the pixel as a starting point and the target camera location as an end point, a virtual detection line corresponding to the pixel; and determine, for each face element point, the face element point as the target face element point when the virtual detection line corresponding to the pixel passes through the face element point.

In some embodiments, the picture shading module is further configured to: obtain a plurality of illumination intensity-adjustment coefficient index entries, and determine a target index entry including the illumination intensity of the target face element point from the plurality of illumination intensity-adjustment coefficient index entries; determine an adjustment coefficient in the target index entry as a target adjustment coefficient of the pixel; and determine a product of the face element color value and the target adjustment coefficient as a reference color value, and set the color value of the pixel to the reference color value, to obtain the shaded pixel.

An embodiment of this disclosure provides a computer program product. The computer program product includes a computer program or computer-executable instructions. The computer program or the computer-executable instructions are stored in a computer-readable storage medium. A processor of an electronic device reads the computer-executable instructions from the computer-readable storage medium. The processor executes the computer-executable instructions, so that the electronic device performs the virtual picture generation method provided in the embodiments of this disclosure.

An embodiment of this disclosure provides a computer-readable storage medium, having computer-executable instructions stored therein. The computer-executable instructions, when executed by a processor, cause the processor to perform the virtual picture generation method provided in the embodiments of this disclosure, for example, the virtual picture generation method shown in FIG. 3.

In some embodiments, the computer-readable storage medium may be a memory such as a read-only memory (ROM), a random access memory (RAM), an erasable programmable read-only memory (EPROM), a flash memory, a magnetic surface memory, an optical disc, or a compact disc read-only memory (CD-ROM); or may be various electronic devices including one of or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit suitable for use in a computing environment.

In an example, the computer-executable instructions may but do not necessarily correspond to a file in a file system, and may be stored as a part of a file that saves other programs or data, for example, stored in one or more scripts in a Hypertext Markup Language (HTML) document, stored in a single file dedicated to a discussed program, or stored in a plurality of collaborative files (for example, files that store one or more modules, subprograms, or code parts).

In the embodiments of this disclosure, a term “module” or “unit” is a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

In an example, the computer-executable instructions may be deployed to be executed on one electronic device, on a plurality of electronic devices located at one site, or on a plurality of electronic devices distributed at a plurality of locations and connected to each other by using a communication network.

In summary, the embodiments of this disclosure have the following beneficial effects.

(1) The preset virtual scene is obtained, and rasterization is performed for each voxel in the preset virtual scene to obtain the voxel face elements corresponding to the voxel. In this way, all voxel face elements in the preset virtual scene are obtained. For any frame of target virtual picture of the preset virtual scene, a target voxel face element associated with the target virtual camera is directly selected from the plurality of voxel face elements, to obtain the target virtual picture. In this way, even if there may be a voxel overlap between different virtual pictures, because all the voxel face elements in the preset virtual scene have been determined in advance, the target virtual picture can be generated by directly selecting the target voxel face element associated with the target virtual camera from the plurality of voxel face elements, without performing a same processing process on a duplicate voxel between different picture frames. Therefore, virtual picture generation efficiency is effectively improved.

(2) The initial camera location of the initial virtual camera in the reference virtual scene and the voxel location of each initial voxel in the reference virtual scene are obtained, the distance between the initial camera location and each voxel location is determined, and the size of each initial voxel in the reference virtual scene is adjusted based on the distance, to obtain the preset virtual scene. Because the adjusted size of the initial voxel is negatively correlated with the corresponding distance, a size of an initial voxel far away from the initial virtual camera is small, and a size of an initial voxel close to the initial virtual camera is large. Therefore, a voxel in the preset virtual scene that is closer to the initial virtual camera can cover more scene information of the initial virtual scene, scene precision of the voxel in the preset virtual scene that is closer to the initial virtual camera is higher, and scene precision of a voxel that is farther from the initial virtual camera is lower. Therefore, resource occupation of the preset virtual scene is effectively reduced, the obtained preset virtual scene better conforms to real visual effects, and resource utilization of the preset virtual scene is effectively improved.

(3) When there are a plurality of candidate object points located in the voxel, and the connection line between the candidate object point and each point on the voxel face passes through no other candidate object point, the candidate object point is determined as a reference object point, and the reference object point closest to the voxel face is determined as the target object point, so that the determined target object point is an object point in the voxel that is closest to the voxel face and that is not occluded by another candidate object point. Therefore, the determined target object point can accurately reflect the scene feature of the corresponding voxel face, and the determined voxel face element is more accurate.

(4) When there are a plurality of candidate object points located in the voxel, and the object point closest to the voxel face is directly determined as the target object point, so that the determined target object point is an object point in the voxel that is closest to the voxel face. Therefore, the target object point that can accurately reflect the scene feature of the corresponding voxel face is determined most efficiently, and the determined voxel face element is more accurate.

(5) When the detection information of the virtual detection line indicates that the virtual detection line corresponding to the voxel face passes through no other voxel face in the preset virtual scene, there is no occlusion between the target virtual camera and the voxel face in the preset virtual scene. In other words, the target virtual camera corresponding to the target virtual picture in the preset virtual scene can acquire the voxel face element. In this case, the voxel face element is determined as the target voxel face element, to subsequently perform picture shading on the preset virtual scene based on the target voxel face element, to obtain the target virtual picture. Therefore, participation of a voxel face element other than the target voxel face element in a picture shading computation process is avoided, and picture shading efficiency is effectively improved.

(6) When the picture information indicates that the target virtual picture is not the first video frame of the video, and the distance between the reference camera location and the target camera location is less than the distance threshold, there is a small deviation between the shooting angles for the preset virtual scene at the reference camera location and the target camera location, and the reference virtual picture is directly determined as the target virtual picture. In this way, the reference virtual picture is reused as the target virtual picture, effectively reducing a time length for generating the target virtual picture and effectively improving efficiency of generating the target virtual picture.

(7) The face element color value is adjusted based on the illumination intensity and the target adjustment coefficient of the target face element point, and the pixel is shaded using the obtained reference color value, so that a color presented by the shaded pixel can more accurately reflect a color of the target face element point in the preset virtual scene, effectively improving presentation effects of the target virtual picture.

(8) The illumination intensity is negatively correlated with the adjustment coefficient. In other words, a larger illumination intensity corresponds to a smaller adjustment coefficient, so that the reference color value corresponding to a product value of the face element color value and the target adjustment coefficient is smaller, making the reference color value brighter. A smaller illumination intensity corresponds to a larger adjustment coefficient, so that the reference color value corresponding to the product value of the face element color value and the target adjustment coefficient is larger, making the reference color value darker.

(9) When the distance between the reference camera location and the target camera location is greater than or equal to the distance threshold, there is a large deviation between shooting angles for the preset virtual scene at the reference camera location and the target camera location. In other words, there is a large difference between pictures of the preset virtual scene acquired by the reference virtual camera and the target virtual camera. In this case, the reference virtual picture cannot be reused as the target virtual picture. Therefore, the target voxel face element associated with the target virtual camera may be selected from the plurality of voxel face elements, to determine the target virtual picture corresponding to the target voxel face element. This effectively improves accuracy of displaying the target virtual picture.

(10) In the embodiments of this disclosure, the rendering result of the previous frame is reused and introduced into finite element GI, and software ray tracing may return the coordinates of the location of the ray hit point. In the conventional solution, the face elements around the location are traversed, and the weighted average of the illumination information is used as the color of this point. This solution in which the color information is entirely obtained from the face elements is limited. Because the representation of the scene is discretized, some high-precision scene information cannot be obtained. For example, for the foregoing planes of the four colors, only one color can be obtained. Therefore, for the ray whose ray hit point is within the screen, in the embodiments of this disclosure, the value x between 0 and 1 is set: the ray has the probability of x to average the face elements according to the conventional solution, and has the probability of (1-x) to reuse the rendering result of the previous frame. The final color of the pixel in the previous frame is read as the color returned by the ray. Rays are cast in each frame in large quantities and random directions. A large quantity of rays are cast onto the plane, and some rays directly use the color of this point as a return value. In this way, the problem of information loss caused by scene discretization is greatly alleviated.

(11) In terms of face element generation, voxelization and rasterization are combined. In a vertex shading process, each grid vertex in a scene is traversed in three directions of X, Y, and Z axes, to find a vertex closest to a current plane, and key information such as world space coordinates, a normal line, and a color is stored. In a face element generation process, the information may be directly read to generate all face elements in a global scope at a time, avoiding problems caused by generation from a screen space in each frame in a conventional solution, such as high performance overheads, slow convergence of the scene, and incapability of controlling a generation density using geometric information of an object, and achieving good anisotropy. In a voxelization process, a farther distance from a camera indicates higher sparsity of generated face elements, so that performance overheads are further reduced. In a final illumination acquisition process, for an illumination acquisition point in the screen space, in this embodiment of this disclosure, a scene rendering result of a previous frame is reused, so that a quantity of times of traversing a face element cache is reduced, information is added, and performance is further improved.

(12) In this way, whether a current video frame is the first frame is checked, so that visual consistency between video frames can be ensured, and an abrupt picture transition can be avoided. The reference virtual picture and the location of the target virtual camera are obtained, helping keep scene continuity, so that a user feels a smooth transition when watching the video. The target voxel face element is dynamically selected based on the distance between the reference camera location and the target camera location, so that scene rendering is more flexible and adapts to changes. If the target virtual picture is not the first video frame, computation does not need to be performed again for the entire scene, so that computing resources can be saved. Only the voxel face element associated with the target virtual camera is processed, so that a rendering load is reduced, and the rendering efficiency is improved. The voxel face element most correlated with the target virtual camera is selected, so that a rendering result can be optimized to provide clearer visual effects. A difference between the reference camera location and the target camera location is allowed, to support movements and dynamic changes of the camera in the scene.

(13) More accurate scene analysis and object detection can be implemented by determining, in the preset virtual scene, the detection information of the virtual detection line corresponding to the voxel face. When the detection information indicates that the virtual detection line passes through no other voxel face in the scene, a possibility of misrecognition or overlapping of an object can be eliminated, improving accuracy of scene understanding. Determining the voxel face element as the target voxel face element can help optimize a data structure, so that subsequent processing is more efficient. The target voxel face element is recognized, so that unnecessary rendering computation can be reduced, and only a key face element is rendered, improving rendering efficiency. Excluding a non-target voxel face element can make the scene more clearly visualized and reduce visual clutter. Only a virtual detection line that does not intersect another voxel face is processed, so that unnecessary computation is reduced, and an overall processing speed is improved. In a game or simulation environment, reducing a quantity of geometric bodies that need to be rendered can significantly improve performance, and ensure smooth user experience.

(14) The candidate object point in the voxel is selected as the target object point, so that an object location in the scene can be determined more precisely, improving accuracy of the entire scene. When there is only one candidate object point in the voxel, the candidate object point is directly determined as the target object point, so that misrecognition caused by noise or other interference factors can be effectively reduced. When a plurality of candidate object points is processed, only a reference object point whose connection line to the voxel face passes through no other candidate object point is considered, so that a computation amount for subsequent processing can be reduced, and performance can be optimized. A conflict or an overlap between object points can be avoided, and a target object point within each voxel is ensured to be unique, facilitating object segmentation and recognition. In a virtual reality or three-dimensional visual application, precisely recognizing a target object point can improve rendering visual effects and reduce visual distortion. When there are a plurality of candidate object points, a reference object point closest to the voxel face is selected as the target object point, so that a more complex decision-making process can be supported, such as path planning and collision detection. The candidate object point is screened and determined, so that robustness of the entire processing process is improved, and the processing process is insensitive to a small change in inputted data. The final target object point is selected, so that redundancy in scene data can be reduced, facilitating storage and transmission.

(15) A distance between a camera and a voxel is obtained, and a size of the voxel is adjusted based on a mapping relationship, so that a scene can be rendered more accurately, and a rendering result is closer to visual effects of a real world. The size of the voxel is allowed to be dynamically adjusted based on the location of the camera, so that scene rendering can a voxel size to be dynamically adjusted according to a camera location, so that scene rendering can be updated in real time based on a viewing angle of an observer, enhancing immersion and interactivity. The size of the voxel is adjusted, so that rendering performance can be optimized at different viewing distances. For voxels far away from the camera, details may be reduced, to reduce rendering costs. The mapping relationship of the size of the voxel is predefined, so that a target size of each voxel can be quickly determined in a rendering process, reducing a computation amount and improving rendering efficiency. A level of detail can be dynamically adjusted based on the distance from the camera, so that a nearby object is displayed at a higher level of detail, and a distant object is appropriately simplified, improving overall visual effects.

(16) The initial virtual scene is divided into voxels having the same size, so that uniform allocation of computing resources to each target can be ensured, improving processing efficiency. The same voxel size can simplify a subsequent computing process because a same algorithm and computing method may be used during processing, reducing complexity. The voxels of the same size can use a storage space more efficiently because the voxels are arranged more regularly in a data structure. Uniform voxel division makes parallel processing easier because each voxel may be independently processed by a different processing unit. During three-dimensional graphic rendering, a voxelized scene can help perform light and shadow computation more quickly because a same rendering policy may be used for the voxels of the same size.

The foregoing descriptions are merely the embodiments of this disclosure and are not intended to limit the protection scope of this disclosure. Any modification, equivalent replacement, or improvement made within the spirit and scope of this disclosure fall within the protection scope of this disclosure.

What is claimed is:

1. A virtual picture generation method, comprising:
obtaining a preset virtual scene, the preset virtual scene comprising a plurality of voxels, wherein each of the plurality of voxels comprise a plurality of voxel faces having different normal directions;
performing, for each voxel, rasterization on the voxel in each normal direction of the voxel to obtain a voxel face element corresponding to each voxel face of the voxel, the voxel face element being configured for describing virtual scene information of the voxel in a corresponding normal direction;
selecting a target voxel face element associated with a target virtual camera in the preset virtual scene from a plurality of voxel face elements; and
performing picture shading on the preset virtual scene based on the target voxel face element, to obtain a target virtual picture.

2. The method according to claim 1, wherein obtaining the preset virtual scene comprises:
obtaining an initial virtual scene, and performing voxelization on the initial virtual scene to obtain a reference virtual scene comprising a target quantity of initial voxels;
obtaining an initial camera location of an initial virtual camera in the reference virtual scene and a voxel location of each initial voxel in the reference virtual scene; and
determining a distance between the initial camera location and each voxel location in the reference virtual scene, and adjusting a size of each initial voxel in the reference virtual scene based on the distance, to obtain the preset virtual scene.

3. The method according to claim 2, wherein adjusting the size of each initial voxel in the reference virtual scene based on the distance, to obtain the preset virtual scene comprises:
obtaining a mapping relationship between a size of each voxel in the preset virtual scene and the distance between the initial camera location and each voxel location in the reference virtual scene, the distance between the initial camera location and each voxel location in the reference virtual scene in the mapping relationship being positively correlated with the size of each voxel; and
performing the following processing for each initial voxel in the reference virtual scene, to obtain the preset virtual scene:
determining a target size of the initial voxel based on the mapping relationship and the distance between the initial camera location and a voxel location corresponding to the initial voxel; and
adjusting the size of the initial voxel in the reference virtual scene to the target size, to obtain a voxel corresponding to the initial voxel.

4. The method according to claim 3, wherein determining the target size of the initial voxel based on the mapping relationship and the distance between the initial camera location and the voxel location corresponding to the initial voxel comprises:
determining an index entry comprising the distance corresponding to the voxel location from a plurality of index entries of the mapping relationship as a target index entry; and
determining a size in the target index entry as the target size.

5. The method according to claim 2, wherein performing voxelization on the initial virtual scene to obtain the reference virtual scene comprising the target quantity of the initial voxels comprises:
obtaining a scene size of the initial virtual scene, and dividing the scene size by the target quantity to obtain the size of the initial voxel; and
dividing the initial virtual scene into a target quantity of the initial voxels of a corresponding size, to obtain the reference virtual scene comprising the target quantity of the initial voxels, each initial voxel in the reference virtual scene having a same size.

6. The method according to claim 1, wherein the preset virtual scene comprises a plurality of virtual objects, the virtual object comprises a plurality of object points, and performing rasterization on the voxel in each normal direction of the voxel to obtain the voxel face element corresponding to each voxel face of the voxel comprises:
determining at least one candidate object point located in the voxel from the plurality of object points in the preset virtual scene; and
performing the following processing in the preset virtual scene for each voxel face of the voxel:
selecting at least one target object point from the at least one candidate object point, a connection line between the target object point and each point on the voxel face passing through no other candidate object point; and
performing rasterization on the voxel based on the target object point, to obtain the voxel face element corresponding to the voxel face.

7. The method according to claim 6, wherein performing rasterization on the voxel based on the target object point, to obtain the voxel face element corresponding to the voxel face comprises:
obtaining vertex data of the target object point, the vertex data being configured for indicating a geometric primitive of the target object point in the preset virtual scene; and
performing rasterization on the vertex data of the target object point in the voxel to obtain the voxel face element corresponding to the voxel face.

8. The method according to claim 6, wherein selecting the at least one target object point from the at least one candidate object point comprises:
determining, when there is one candidate object point located in the voxel, the candidate object point as the target object point; or
performing, when there are a plurality of candidate object points located in the voxel, the following processing for each candidate object point:
determining the candidate object point as a reference object point when a connection line between the candidate object point and each point on the voxel face passes through no other candidate object points; and
determining a reference object point closest to the voxel face as the target object point.

9. The method according to claim 1, wherein selecting the target voxel face element associated with the target virtual camera in the preset virtual scene from the plurality of voxel face elements comprises:
obtaining a target camera location of the target virtual camera, the target virtual camera being configured to acquire picture information of the target virtual picture in the preset virtual scene;
generating, in the preset virtual scene using a central location of each voxel face as a starting point and the target camera location as an end point, a virtual detection line corresponding to each voxel face; and
selecting, based on the virtual detection line, the target voxel face element associated with the target virtual camera from the voxel face elements corresponding to the voxel faces.

10. The method according to claim 9, wherein selecting, based on the virtual detection line, the target voxel face element associated with the target virtual camera from the voxel face elements corresponding to the voxel faces comprises:
performing the following processing for the voxel face element corresponding to each voxel face:
determining, in the preset virtual scene, detection information of the virtual detection line corresponding to the voxel face; and
determining the voxel face element as the target voxel face element when the detection information indicates that the virtual detection line corresponding to the voxel face passes through no other voxel face in the preset virtual scene.

11. The method according to claim 9, wherein before selecting the target voxel face element associated with the target virtual camera in the preset virtual scene from the plurality of voxel face elements, the method further comprises:
obtaining the picture information of the target virtual picture, the picture information being configured for indicating whether the target virtual picture is a first video frame of a video corresponding to the preset virtual scene; and
selecting the target voxel face element associated with the target virtual camera in the preset virtual scene from the plurality of voxel face elements comprises:
selecting the target voxel face element associated with the target virtual camera from the plurality of voxel face elements in response to the picture information indicating that the target virtual picture is the first video frame.

12. The method according to claim 11, wherein after obtaining the picture information of the target virtual picture, the method further comprises:
obtaining a reference virtual picture in the video in response to the picture information indicating that the target virtual picture is not the first video frame, the reference virtual picture being a previous frame of virtual picture of the target virtual picture in the video; and
obtaining a reference camera location of a reference virtual camera in the preset virtual scene and the target camera location of the target virtual camera in the preset virtual scene,
the reference virtual camera being configured to acquire picture information of the reference virtual picture in the preset virtual scene, and the target virtual camera being configured to acquire the picture information of the target virtual picture in the preset virtual scene; and
selecting the target voxel face element associated with the target virtual camera from the plurality of voxel face elements comprises:
selecting the target voxel face element associated with the target virtual camera from the plurality of voxel face elements in response to a distance between the reference camera location and the target camera location being greater than or equal to a distance threshold.

13. The method according to claim 12, wherein after obtaining the reference camera location of the reference virtual camera in the preset virtual scene and the target camera location of the target virtual camera in the preset virtual scene, the method further comprises:
determining the reference virtual picture as the target virtual picture in response to the distance between the reference camera location and the target camera location being less than the distance threshold.

14. The method according to claim 13, wherein the target voxel face element comprises a plurality of face element points, and performing picture shading on the preset virtual scene based on the target voxel face element, to obtain the target virtual picture comprises:
acquiring the picture information of the target virtual picture in the preset virtual scene via the target virtual camera, and generating an initial virtual picture of the preset virtual scene based on the picture information, a pixel of the initial virtual picture being in one-to-one correspondence with a pixel of the target virtual picture; and
performing the following processing for each pixel of the initial virtual picture to obtain the target virtual picture:
selecting a target face element point associated with the pixel from the plurality of face element points of the target voxel face element, and obtaining an illumination intensity of the target face element point; and
obtaining a face element color value of the target face element point when a value of the illumination intensity is not equal to zero, and shading the pixel based on the face element color value, to obtain a shaded pixel; or
obtaining a target color value when a value of the illumination intensity is equal to zero, and setting a color value of the pixel to the target color value, to obtain a shaded pixel, the target color value being different from the face element color value.

15. The method according to claim 14, wherein selecting the target face element point associated with the pixel from the plurality of face element points of the target voxel face element comprises:
obtaining the target camera location of the target virtual camera in the preset virtual scene, and generating, in the preset virtual scene using the pixel as a starting point and the target camera location as an end point, a virtual detection line corresponding to the pixel; and
determining, for each face element point, the face element point as the target face element point when the virtual detection line corresponding to the pixel passes through the face element point.

16. The method according to claim 14, wherein shading the pixel based on the face element color value, to obtain the shaded pixel comprises:
obtaining a plurality of illumination intensity-adjustment coefficient index entries, and determining a target index entry comprising the illumination intensity of the target face element point from the plurality of illumination intensity-adjustment coefficient index entries;
determining an adjustment coefficient in the target index entry as a target adjustment coefficient of the pixel; and
determining a product of the face element color value and the target adjustment coefficient as a reference color value, and setting the color value of the pixel to the reference color value, to obtain the shaded pixel.

17. A virtual picture generation apparatus, comprising a display configured to show a virtual scene to a user, a memory configured to store computer readable instructions, and a processor configured to execute the computer readable instructions to:
obtain a preset virtual scene, the preset virtual scene comprising a plurality of voxels, wherein each one of the plurality of voxels comprises a plurality of voxel faces having different normal directions;
perform, for each voxel, rasterization on the voxel in each normal direction of the voxel to obtain a voxel face element corresponding to each voxel face of the voxel, the voxel face element being configured for describing virtual scene information of the voxel in a corresponding normal direction;
select a target voxel face element associated with a target virtual camera in the preset virtual scene from a plurality of voxel face elements; and
perform picture shading on the preset virtual scene based on the target voxel face element, to obtain a target virtual picture.

18. The apparatus according to claim 17, wherein the processor, when executing the computer readable instructions to obtain the preset virtual scene, is configured to:
obtain an initial virtual scene, and perform voxelization on the initial virtual scene to obtain a reference virtual scene comprising a target quantity of initial voxels;
obtain an initial camera location of an initial virtual camera in the reference virtual scene and a voxel location of each initial voxel in the reference virtual scene; and
determine a distance between the initial camera location and each voxel location in the reference virtual scene, and adjust a size of each initial voxel in the reference virtual scene based on the distance, to obtain the preset virtual scene.

19. The apparatus according to claim 17, wherein the processor, when executing the computer readable instructions to select the target voxel face element associated with the target virtual camera in the preset virtual scene from the plurality of voxel face elements, is further configured to:
obtain a target camera location of the target virtual camera, the target virtual camera being configured to acquire picture information of the target virtual picture in the preset virtual scene;
generate, in the preset virtual scene using a central location of each voxel face as a starting point and the target camera location as an end point, a virtual detection line corresponding to each voxel face; and
select, based on the virtual detection line, the target voxel face element associated with the target virtual camera from the voxel face elements corresponding to the voxel faces.

20. A non-transitory computer-readable storage medium, having computer-executable instructions stored therein, the computer-executable instructions, when executed by a processor, cause the processor to:
obtain a preset virtual scene, the preset virtual scene comprising a plurality of voxels, and the voxel comprising a plurality of voxel faces having different normal directions;
perform, for each voxel, rasterization on the voxel in each normal direction of the voxel to obtain a voxel face element corresponding to each voxel face of the voxel, the voxel face element being configured for describing virtual scene information of the voxel in a corresponding normal direction; and
select a target voxel face element associated with a target virtual camera in the preset virtual scene from a plurality of voxel face elements; and perform picture shading on the preset virtual scene based on the target voxel face element, to obtain a target virtual picture.
